(19) United States
(12) Patent Application Publication
(10) Pub. No.: US 2021/0105611 A1
(43) Pub. Date: Apr. 8, 2021

(54) USER EQUIPMENT RADIO CAPABILITY PROTECTION

(71) Applicant: QUALCOMM Incorporated, San Diego, CA (US)

(72) Inventors: Soo Bum LEE, San Diego, CA (US); Adrian Edward ESCOTT, Reading (GB); Anand PALANIGOUNDER, San Diego, CA (US); Haris ZISIMOPOULOS, London (GB)

(21) Appl. No.: 16/985,936

(22) Filed: Aug. 5, 2020

Related U.S. Application Data
(60) Provisional application No. 62/911,140, filed on Oct. 4, 2019.

(51) Int. Cl. H04W 8/24; H04W 60/00; H04L 9/06; H04W 76/27; H04L 9/08; H04W 76/25

(52) U.S. Cl. CPC H04W 8/24; H04W 60/00; H04W 76/25; H04W 76/27; H04L 9/0869; H04L 9/0643

(57) ABSTRACT

Aspects relate to security mechanisms for protecting transmissions in wireless communication systems. Various examples provide and enable techniques for protecting transmissions of user equipment (UE) radio capability information. A UE may transmit a hash of its UE radio capability information to a network. The network can then utilize the hash to verify the integrity of the UE's radio capability information upon acquiring the full UE radio capability information during a UE Capability Enquiry procedure. Other aspects, embodiments, and features are also claimed and described.

### CROSS-REFERENCE TO RELATED APPLICATIONS

The present Application for Patent claims priority to pending U.S. Provisional Application No. 62/911,140, titled “USER EQUIPMENT RADIO CAPABILITY PROTECTION FOR CONTROL PLANE-ONLY CELLULAR INTERNET OF THINGS DEVICES” filed Oct. 4, 2019, and assigned to the assignee hereof and hereby expressly incorporated by reference herein as if fully set forth below and for all applicable purposes.

### TECHNICAL FIELD

The technology discussed below relates generally to wireless communication systems, and more particularly, to security mechanisms for protecting transmissions in wireless communication systems. Embodiments can provide and enable techniques for protecting transmissions of user equipment (UE) radio capability information from various UE devices, such as control plane-only cellular Internet-of-Things devices.

### INTRODUCTION

Cellular Internet-of-Things (CIoT) devices include certain machine-type communication (MTC) devices that are capable of communicating utilizing a cellular network (e.g., a 5^{th} generation (5G) New Radio (NR) and/or 4^{th} generation (4G) evolved UTRA radio access network (E-UTRAN)). CIoT devices may generally be characterized by their small data transmission, high latency communication, power-saving functions, and other supporting functions.

In E-UTRAN, specifications for certain CIoT devices support the transmission of user data over the control plane (CP) without triggering data radio bearer (DRB) establishment. This feature is generally referred to as CP optimization. However, such a CIoT device that only supports CP optimization does not support user-plane CIoT optimizations and data transfer over the user plane. With E-UTRAN CP optimization, communication of both uplink and downlink data are performed at the radio resource control (RRC) layer, by including data packets within existing RRC protocol messages. In this manner, this procedure is transparent to the base station.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

According to some aspects, techniques discussed below enable and provide security mechanisms for protecting transmissions in wireless communication systems. Various examples provide and enable techniques for protecting transmissions of user equipment (UE) radio capability information from CP-only CIoT devices. Rather than transmitting its full UE radio capability information over NAS signaling, a UE may include a hash of its radio capabilities. The network can then utilize the hash to verify the UE's radio capabilities when it acquires the full UE radio capability information message during a UE Capability Enquiry procedure.

In one example, a method for wireless communication at a user equipment (UE) is disclosed. The method can include determining UE radio capability information including radio capabilities of the UE, computing a hash of the UE radio capability information, and transmitting a message to a core network node. The message can include the hash. The method can further include receiving a request for UE radio capability information from a radio access network (RAN) node, and transmitting the UE radio capability information to the RAN node.

Another example provides a user equipment (UE) configured for wireless communication including a transceiver configured to communicate over a wireless link with a radio access network (RAN) node, a memory, and a processor coupled to the wireless transceiver and the memory. The processor and the memory can be configured to determine UE radio capability information including radio capabilities of the UE, compute a hash of the UE radio capability information, and transmit a message to a core network node. The message can include the hash. The processor and the memory can further be configured to receive a request for UE radio capability information from the RAN node, and transmit the UE radio capability information to the RAN node.

Various method, system, device, and apparatus embodiments may also include additional features. For example, the UE may further be configured to register with the core network node upon verification of the hash. In addition, the UE may be configured to communicate data packets within radio resource control (RRC) messages over a control plane between the UE and the core network node.

In some examples, the UE may further be configured to append a random number to the UE radio capability information to produce a full sequence including the UE radio capability information and the random number, and compute the hash of the full sequence. The UE may further be configured to transmit the message including the hash and the random number to the core network node. In some examples, the random number includes a one-time sequence. In some examples, the message includes a non-access stratum (NAS) registration request or a NAS service request. In some examples, the UE is a cellular internet-of-things (CIoT) device.

Another example provides method for a core network node to receive user equipment (UE) capability information. The method can include receiving a message from the UE. The message can include a first hash of the UE radio capability information. The method can further include transmitting a UE radio capability information request to a radio access network (RAN) node in wireless communication with the UE and receiving a response from the RAN node. The response can include the UE radio capability information. The method can further include verifying an integrity of the UE radio capability information received from the RAN node using the first hash.

Another example provides a core network node within a core network that includes a network interface, a memory, and a processor coupled to the network interface and the memory. The processor and the memory can be configured to receive a message from the UE via the network interface. The message can include a first hash of the UE radio capability information. The processor and the memory can further be configured to transmit a UE radio capability information request to a radio access network (RAN) node in wireless communication with the UE via the network interface and receive a response from the RAN node via the network interface. The response can include the UE radio capability information. The processor and the memory can further be configured to verify an integrity of the UE radio capability information received from the RAN node using the first hash.

Various method, system, device, and apparatus embodiments may also include additional features. For example, the core network node may further be configured to compute a second hash of the UE radio capability information received from the RAN node, compare the first hash with the second hash, and successfully verify the integrity of the UE radio capability information when the second hash matches the first hash. In some examples, the core network node may further be configured to register the UE upon successfully verifying the integrity of the UE radio capability information. In some examples, the core network node may further be configured to communicate data packets within radio resource control (RRC) messages over a control plane between the UE and the core network node.

In some examples, the core network node may further be configured to transmit a signal to the RAN node indicating a hash mismatch when the first hash does not match the second hash. In some examples, the message further includes a random number and the first hash includes a full hash of the UE radio capability information and the random number appended to the UE radio capability information. In this example, the core network node may further be configured to compute the second hash of the UE radio capability information and the random number appended to the UE radio capability information. In some examples, the random number includes a one-time sequence. In some examples, the core network node may further be configured to set a UE radio capabilities verified flag to one when the first hash matches the second hash.

In some examples, the core network node may further be configured to access pre-stored UE radio capability information for the UE, compute a third hash of the pre-stored UE radio capability information, compare the first hash to the third hash, and transmit the UE radio capability information request to the RAN node when the first hash does not match the third hash.

These and other aspects of the invention will become more fully understood upon a review of the detailed description, which follows. Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a schematic illustration of a wireless communication system according to some aspects.

FIG. 2 is a conceptual illustration of an example of a radio access network according to some aspects.

FIG. 3 is a schematic illustration of an example of a next-generation radio access network (NG-RAN) according to some aspects of the disclosure.

FIG. 4 is a block diagram illustrating some of the functions of logical nodes in an example of a 5G NR network that employs a NG-RAN according to some aspects.

FIG. 5 is a call flow diagram illustrating an example of a UE Capability Enquiry procedure according to some aspects.

FIG. 6 is a call flow diagram illustrating an exemplary mechanism for protecting UE radio capability information according to some aspects.

FIG. 7 is a call flow diagram illustrating another exemplary mechanism for protecting UE radio capability information according to some aspects.

FIG. 8 is a call flow diagram illustrating another exemplary mechanism for protecting UE radio capability information according to some aspects.

FIG. 9 is a block diagram conceptually illustrating an example of a hardware implementation for a UE according to some aspects.

FIG. 10 is a block diagram conceptually illustrating an example of a hardware implementation for a RAN node according to some aspects.

FIG. 11 is a block diagram conceptually illustrating an example of a hardware implementation for a core network node according to some aspects.

FIG. 12 is a flow chart of an exemplary method for a UE to protect UE radio capability information according to some aspects.

FIG. 13 is a flow chart of an exemplary method for a UE to compute a hash of UE radio capability information according to some aspects.

FIG. 14 is a flow chart of an exemplary method for a core network node to protect UE radio capability information according to some aspects.

FIG. 15 is a flow chart of an exemplary method for a core network node to verify the integrity of UE radio capability information according to some aspects.

FIG. 16 is a flow chart of an exemplary method for a core network node to verify the integrity of pre-stored UE radio capability information according to some aspects.

FIG. 17 is a flow chart of an exemplary method for a RAN node to protect UE radio capability information according to some aspects.

FIG. 18 is a flow chart of another exemplary method for a core network node to protect UE radio capability information according to some aspects.

FIG. 19 is a flow chart of another exemplary method for a RAN node to protect UE radio capability information according to some aspects.

FIG. 20 is a flow chart of another exemplary method for a core network node to protect UE radio capability information according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes and constitution.

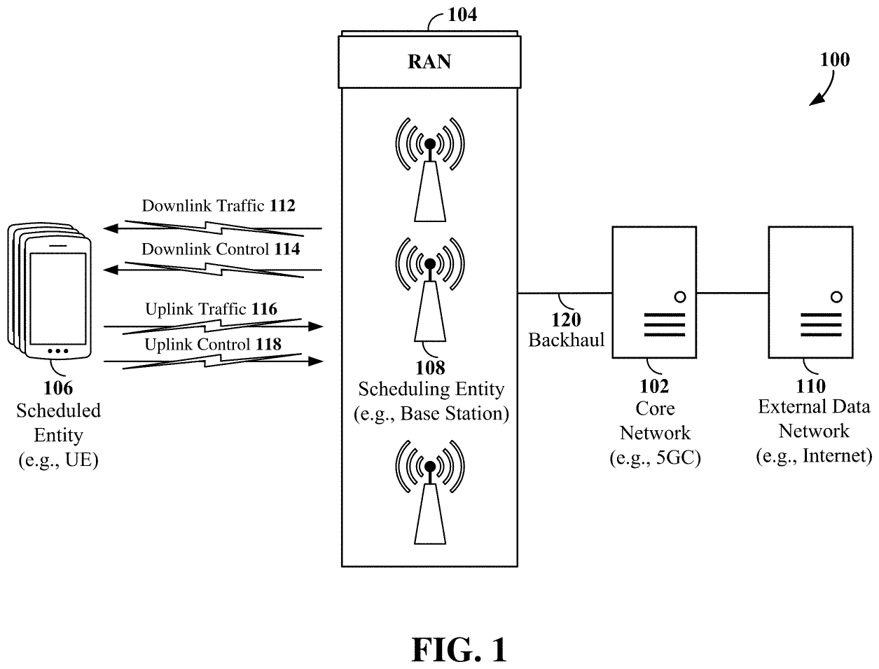

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable radio access technology (RAT) or communication standard for radio access and communication over a wireless air interface to provide radio access to the UE 106. Just a few examples of RATs that might be utilized within the RAN 104 include GSM, UTRA, E-UTRA (LTE), Bluetooth, and Wi-Fi. In some examples, the RAN 104 may implement new radio (NR) technology.

As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. That is, initial deployments of 5G technologies are envisioned to be complementary to existing 4G LTE networks, e.g., by utilizing dual connectivity (DC). DC means that a UE 106 may utilize radio resources provided by two distinct schedulers. Such an NG-RAN includes gNBs and ng-eNBs. A gNB is a base station 108 that provides both 5G user plane and control plane functionality. An ng-eNB is a base station 108 that provides E-UTRA (LTE) user plane and control plane functionality. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), or some other suitable terminology.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present document, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc.; an industrial automation and enterprise device; a logistics controller; agricultural equipment; military defense equipment, vehicles, aircraft, ships, and weaponry, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between a RAN 104 and a UE 106 may be described as utilizing an air interface. Transmissions over the air interface from a base station (e.g., base station 108) to one or more UEs (e.g., UE 106) may be referred to as downlink (DL) transmission. In accordance with certain aspects of the present disclosure, the term downlink may refer to a point-to-multipoint transmission originating at a scheduling entity (described further below; e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a scheduled entity (described further below; e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs).

As illustrated in FIG. 1, a scheduling entity 108 may broadcast downlink traffic 112 to one or more scheduled entities 106. Broadly, the scheduling entity 108 is a node or device responsible for scheduling traffic in a wireless communication network, including the downlink traffic 112 and, in some examples, uplink traffic 116 from one or more scheduled entities 106 to the scheduling entity 108. On the other hand, the scheduled entity 106 is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system. The backhaul 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

From the perspective of the UE 106, communication may be characterized as access stratum (AS) or non-access stratum (NAS) protocols. AS refers to a functional grouping consisting of the parts in the RAN 104 and in the UE 106, and the protocols between these parts being specific to the access technique (i.e., the way the specific physical media between the UE 106 and the RAN 104 is used to carry information). NAS refers to protocols between UE 106 and the core network 102, which are not terminated in the RAN 104. When the core network 102 corresponds to a 5G network, NAS protocols are terminated in the AMF on the network side. And when the core network 102 corresponds to a 4G LTE network, NAS protocols are terminated in the MME on the network side. The Radio Resource Control: protocol is a sublayer of radio interface layer 3, existing in the control plane only, which provides information transfer service to the NAS. RRC is responsible for controlling the configuration of radio interface Layers 1 and 2.

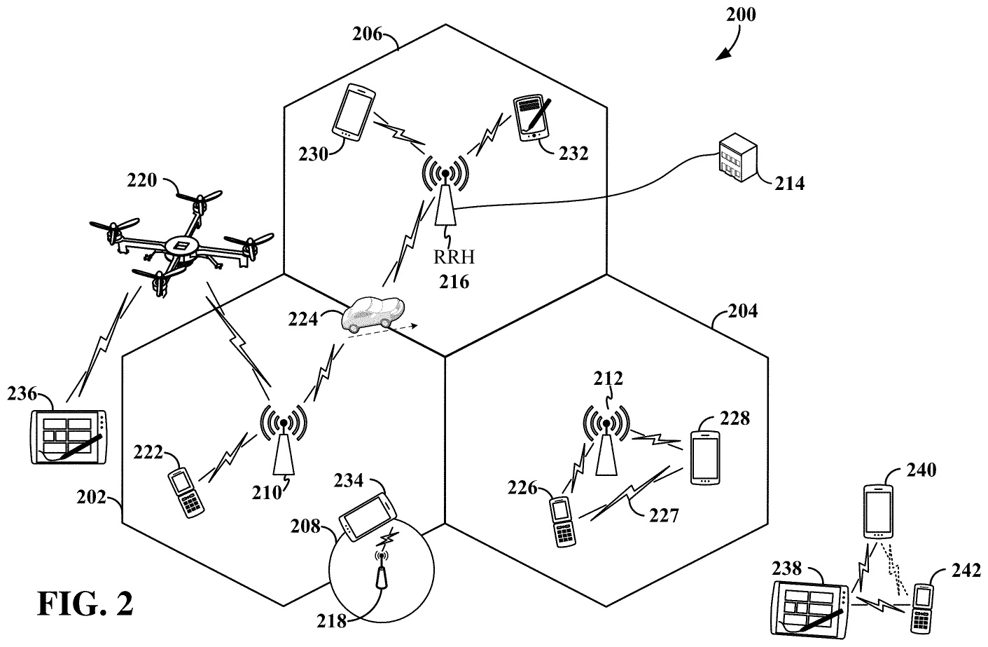

Referring now to FIG. 2, by way of example and without limitation, a schematic illustration of a RAN 200 is provided. In some examples, the RAN 200 may be the same as the RAN 104 described above and illustrated in FIG. 1. The geographic area covered by the RAN 200 may be divided into cellular regions (cells) that can be uniquely identified by a user equipment (UE) based on an identification broadcasted from one access point or base station. FIG. 2 illustrates macrocells 202, 204, and 206, and a small cell 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204; and a third base station 214 is shown controlling a remote radio head (RRH) 216 in cell 206. That is, a base station can have an integrated antenna or can be connected to an antenna or RRH by feeder cables. In the illustrated example, the cells 202, 204, and 206 may be referred to as macrocells, as the base stations 210, 212, and 214 support cells having a large size. Further, a base station 218 is shown in the small cell 208 (e.g., a microcell, picocell, femtocell, home base station, home Node B, home eNode B, etc.) which may overlap with one or more macrocells. In this example, the cell 208 may be referred to as a small cell, as the base station 218 supports a cell having a relatively small size. Cell sizing can be done according to system design as well as component constraints.

It is to be understood that the radio access network 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as the base station/scheduling entity 108 described above and illustrated in FIG. 1.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as the UE/scheduled entity 106 described above and illustrated in FIG. 1.

FIG. 2 further includes a quadcopter or drone 220, which may be configured to function as a base station or as a UE. That is, in some examples, a cell may not necessarily be stationary, and the geographic area of the cell may move according to the location of a mobile base station such as the quadcopter 220. When functioning as a UE, the quadcopter 220 may operate within cell 202 by communicating with base station 210.

In the RAN 200, the ability for a UE to communicate while moving, independent of their location, is referred to as mobility. The various physical channels between the UE and the RAN are generally set up, maintained, and released under the control of an access and mobility management function (AMF). In some scenarios, the AMF may include a security context management function (SCMF). The SCMF can manage, in whole or in part, the security context for both the control plane and the user plane functionality. The AMF may further include a security anchor function (SEAF) that performs authentication. In some examples, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a further aspect of the RAN 200, sidelink signals may be used between UEs without necessarily relying on scheduling or control information from a base station. For example, two or more UEs (e.g., UEs 226 and 228) may communicate with each other using peer to peer (P2P) or sidelink signals 227 without relaying that communication through a base station (e.g., base station 212). In some examples, the sidelink signals 227 include sidelink traffic and sidelink control. In a further example, UE 238 is illustrated communicating with UEs 240 and 242 outside the coverage area of a base station. The UEs 238, 240, and 242 may each function as a scheduling entity or an initiating (e.g., transmitting) sidelink device and/or a scheduled entity or a receiving sidelink device. For example, the UEs 238, 240, and 242 may function as scheduling entities or scheduled entities in a device-to-device (D2D), peer-to-peer (P2P), vehicle-to-vehicle (V2V) network, vehicle-to-everything (V2X), a mesh network, or other suitable network.

The air interface in the radio access network 200 may utilize one or more multiplexing and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier I-DMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

The air interface in the radio access network 200 may further utilize one or more duplexing algorithms. Duplex refers to a point-to-point communication link where both endpoints can communicate with one another in both directions. Full duplex means both endpoints can simultaneously communicate with one another. Half duplex means only one endpoint can send information to the other at a time. In a wireless link, a full duplex channel generally relies on physical isolation of a transmitter and receiver, and suitable interference cancellation technologies. Full duplex emulation is frequently implemented for wireless links by utilizing frequency division duplex (FDD) or time division duplex (TDD). In FDD, transmissions in different directions operate at different carrier frequencies. In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot.

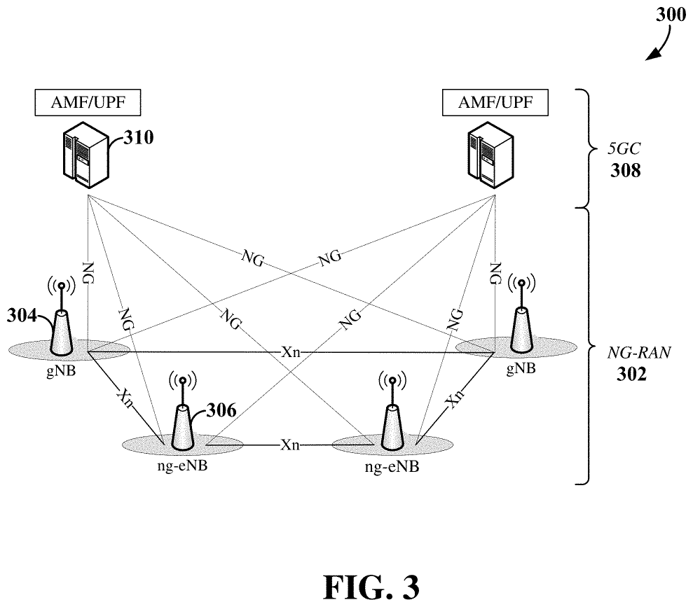

FIG. 3 illustrates an NG-RAN architecture 300 according to some aspects. As described above in relation to FIGS. 1 and 2, an NG-RAN 302 employs dual connectivity (DC), and includes both gNBs 304 and ng-eNBs 306 that are communicatively coupled to a 5GC 308 (e.g., which may include an access and mobility function and user plane function (AMF/UPF) 310). The gNB 304 provides NR user plane and control plane protocol terminations towards a UE, and is connected via the NG interface to the 5GC 308. The ng-eNB 306 provides E-UTRA user plane and control plane protocol terminations towards a UE, and is connected via the NG interface to the 5GC 308. In the present disclosure, an NG-RAN node may refer interchangeably to either a gNB 304 or an ng-eNB 306 operating in an NG-RAN 302.

Within the NG-RAN 302, the gNBs 304 and ng-eNBs 306 are interconnected with each other by means of the Xn interface. The gNBs 304 and ng-eNBs 306 are also connected by means of the NG interfaces to the 5GC 308 (e.g., AMF/UPF 310), more specifically to the AMF by means of an N2 interface and to the UPF by means of an N3 interface.

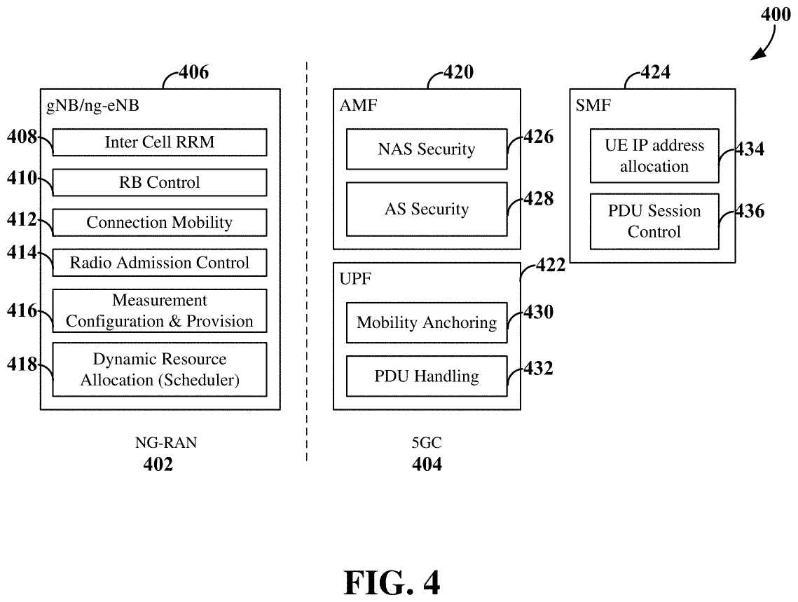

FIG. 4 is a diagram illustrating exemplary functions of different logical nodes in an example of a 5G NR network 400 that employs an NG-RAN 402 and a 5GC network 404 according to some aspects. A gNB and ng-eNB (i.e., an NG-RAN node 406) hosts a variety of functions. For example, the NG-RAN node 406 may include an inter-cell radio resource management entity 408 configured to perform radio resource management, and a radio bearer (RB) control entity 4010 configured to perform routing of user plane data toward UPF(s) and routing of control plane information towards an AMF. The NG-RAN node 406 may further include a connection mobility entity 412 configured to perform handovers of UEs between cells, a radio admission control entity 414 configured to perform connection setup and release, a measurement configuration and provision entity 416 configured to perform uplink channel measurements and provision resources for UE downlink channel measurements, and a dynamic resource allocation entity (scheduler) 418 configured to perform scheduling of uplink and downlink transmissions. The NG-RAN node 406 may further provide other functions and services in the 5G NR network 400.

The 5GC network 404 includes an AMF 420, UPF 422, and session management function (SMF) 424. The AMF 420 provides a large variety of functions including, among others, NAS signaling termination and security, and AS security control. For example, the AMF 420 may include a NAS security entity 426 configured to provide NAS security and an AS security entity 428 configured to provide AS security The UPF 422 provides a large variety of user plane functions. For example, the UPF 422 may include a mobility anchoring entity 430 configured to function as an anchor point for UE mobility, and a protocol data unit (PDU) handling entity 432 entity configured to perform routing, forwarding, and inspection of PDU packets transmitted between a UE and, for example, an external data network. The external data network may be any suitable data network, including but not limited to the Internet, an IP multimedia subsystem (IMS) network, etc. The SMF 424 may include, for example, a UE IP address allocation entity 434 configured to provide UE IP address allocation and management, and a PDU session control entity 436 configured to provide session management, selection and control of a UPF, and other functions.

Deployments of 5G communication infrastructure may include various different network configurations, including but not limited to a standalone NR RAN, a dual-connectivity RAN that includes both NR RAN and E-UTRAN, and others. For a UE that desires to register with such a network, the UE may signal its radio capabilities to the network. However, not all UEs will necessarily have the capability to employ all of the features in any given network.

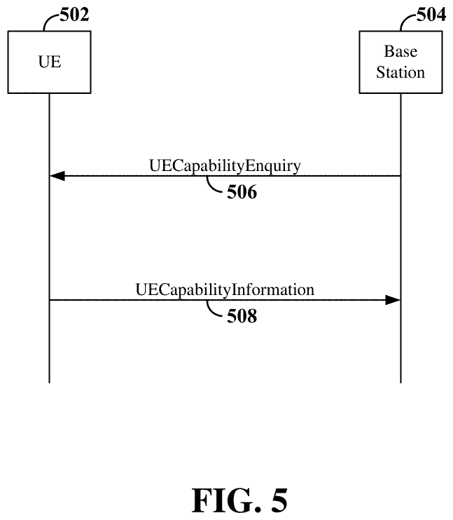

FIG. 5 is a call flow diagram illustrating a UE Capability Enquiry procedure according to some aspects. As illustrated a UE Capability Enquiry procedure takes place between a UE 502 and a base station 504 (e.g., a NG-RAN node). The UE 502 may correspond to any of the UEs or scheduled entities illustrated in any one or more of FIGS. 1 and 2. The base station 504 may correspond to any of the base stations (e.g., gNB, ng-eNB, or other NG-RAN node) or scheduling entities illustrated in any one or more of FIGS. 1-4.

In a 5G NR network, the UE 502 may provide its capability information to the network (e.g., base station 504) utilizing radio resource control (RRC) signaling. In the example shown in FIG. 5, the network (e.g., base station 504) may initiate this procedure by transmitting a RRC ‘UECapabilityEnquiry’ message 506 to the UE 502 to obtain the UE radio access capability information. The UE 502 may respond with an RRC ‘UECapabilitylnformation’ message 508 including the UE radio capability information. The UE radio capability information can include information about the UE's capability to communicate on different RATs (such as a NR, EUTRA-NR, E-UTRA, etc.). In some examples, the UE 502 may provide the base station 504 with the UE radio capability information during Initial context setup. It should be understood that LTE has a similar procedure whereby a UE can provide its capability information to the RAN.

In further detail, the AMF (or, in LTE, the MME) may trigger the UE Capability Enquiry procedure. However, the UE Capability Enquiry procedure itself is performed between the base station 504 and the UE 502. Once received, the UE radio capability information is stored at the AMF (or MME) and provided to gNB (or eNB) when needed.

However, the UE Capability Enquiry procedure, as described above, may be performed before AS security setup. Accordingly, without having the protection of AS security, an attacker could potentially modify the UE radio capability information message. In order to address this issue in 5G NR networks, various RRC security and integrity mechanisms may be implemented to activate AS security (e.g., by performing an AS Security Mode Command (SMC) procedure) before performing the RRC UE capability transfer procedure described above.

However, if the network acquires UE radio capability information using an RRC UE capability transfer procedure prior to AS security activation, with the exception of unauthenticated emergency calls, the network shall not locally store the UE radio capability information for later use, and further, shall not send the UE radio capability information to other network entities. In that case, the network may re-run the RRC UE capability transfer procedure after a successful AS SMC procedure.

While these measures may address the security of UE radio capability information for many devices, it is noted that these measures may not be available for all categories or types of UEs. For example, for Cellular Internet-of-Things (CIoT) devices, 4G LTE networks may support the transmission of user data over the control plane, via the MME (i.e., over the S 1-MME interface, which is the interface between the eNB and the MME and supports control plane signaling), without triggering data radio bearer (DRB) establishment. This feature is generally referred to as CP optimization. However, such a CIoT UE that only supports CP optimization does not support user-plane CIoT optimizations and data transfer over the S1-U interface (i.e., the interface between the eNB and the S-GW, used for transport of user plane data). With LTE CP optimization, communication of both uplink and downlink data are performed at the RRC layer, by including data packets within existing RRC protocol messages. In this manner, this procedure is transparent to the eNB. This data transfer mechanism may begin during or after the RRC connection setup or resume procedure, and AS security is not applied.

Accordingly, CIoT devices that only support CP optimization (CP-only CIoT devices) do not support PDCP layer functions, and therefore, do not establish an AS security context. Because there is no AS security for these devices, there is currently no mechanism to verify whether the UE Radio capability provided by such a CIoT device has been tampered with by an attacker.

While the above refers generally to established specifications for CIoT devices in LTE, it is noted that 5G NR networks may further support CP optimization of CIoT devices. Therefore, within the present disclosure, reference to a CIoT device refers interchangeably to one that operates in either a 4G or 5G network, or any other suitable wireless communication network. In a 5G network, an NG user plane interface (N3) is defined between an NG-RAN node and a UPF, and an NG control plane interface (N2) is defined between the NG-RAN node and the AMF.

Various aspects of the present disclosure provide protection of UE radio capability information for CP-only CIoT devices and other suitable UEs. For example, according to some aspects of the disclosure, a UE may include a hash of its radio capabilities (rather than the full UE radio capability information) in an initial NAS message (e.g., a Registration Request or a Service Request) to the network. The initial NAS message may be security protected using, for example, the security protection mechanism described in version 15 or 16 of 3GPP TS 33.501. The network can then utilize the hash to verify the UE's radio capabilities when it acquires the full UE radio capability information message during the UE Capability Enquiry procedure.

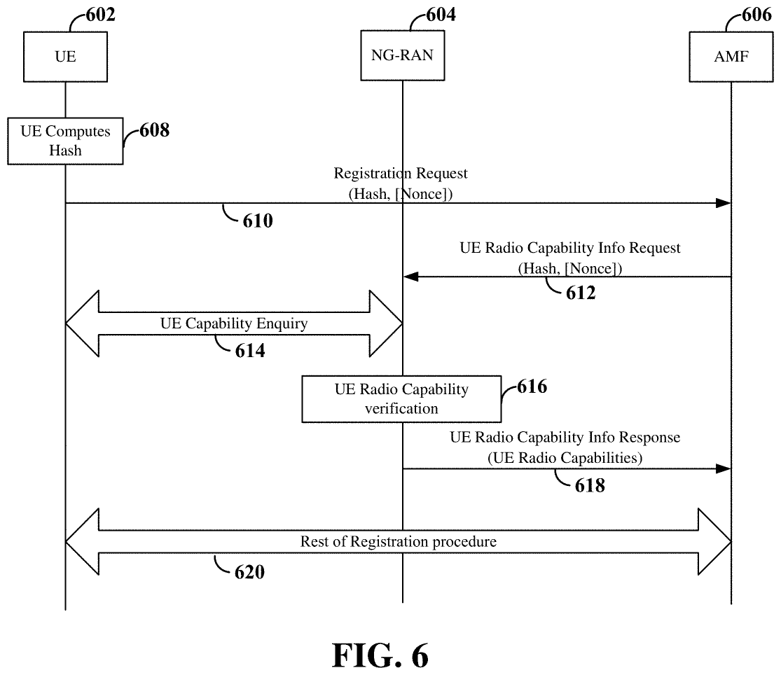

FIG. 6 is a call flow diagram illustrating an exemplary mechanism for protecting UE radio capability information according to some aspects. In the illustration, a UE 602 may be a CP-only CIoT device capable of operating in a wireless communication network. The UE 602 is in the general proximity of a base station functioning within a wireless communication network. In the illustrated example, the base station may be an NG-RAN node 604 (e.g., a gNB or an ng-eNB). The NG-RAN node 604 may be communicatively coupled to a 5GC including an AMF 606, as illustrated. It is to be understood that the disclosure that follows assumes the use of a 5G system (5GS) that includes an NG-RAN and a 5G Core (5GC)). However, the various aspects of this disclosure may be implemented in an EPS (Evolved Packet System that includes an E-UTRAN and an Evolved Packet Core (EPC)) in an essentially equivalent manner, and the scope of this disclosure and the appended claims include such examples. In general, in such an EPS example, the NG-RAN node would be replaced with an eNB, and the AMF would be replaced with an MME.

As discussed above, in an aspect of the disclosure, the UE 602 may perform a hash procedure 608 by which the UE 602 computes a hash of its UE radio capability information. That is, the UE 602 may utilize a suitable hashing algorithm to transform the UE radio capability information into a hash code that represents the UE radio capability information in a way that is difficult or impossible for one who might intercept the message to decode. Any suitable hash function may be utilized within the scope of this disclosure, including but not limited to a Secure Hash Algorithm (SHA) as published by the National Institute of Standards and Technology (NIST), MD5, etc. The UE 602 then transmits a Registration Request message 610, which the NG-RAN node forwards to the AMF 606.The UE 602 further includes the computed hash within the Registration Request message 610.

In a further aspect of the disclosure, the UE 602 may include additional information, such as a random number, along with the UE radio capability information when computing the hash. For example, the UE 602 may append a suitable random sequence to the UE radio capability information element, and apply a suitable hash procedure to the full sequence, including the UE radio capability information and the random number. Any suitable random or pseudo-random number generator algorithm may be utilized in a given example In an example where a random number is utilized in this manner in the hash calculation, the UE 602 may transmit the random number along with the hash. This is represented in FIG. 6 by the optional [Nonce] included with the Hash in the Registration Request message 610, indicating the one-time random sequence.

By including such a random number in the hash calculation, the security of the UE radio capability information may be improved. And furthermore, the possibility of a collision may be reduced. That is, depending on the hash function used and the length of the hash that is included in the Registration Request message 610, different UE radio capability information might result in the same hash. Adding a random number to the information being input to the hash function can reduce this possibility.

In this example, the AMF 606 may not yet store the UE radio capability information of the UE 602. Therefore, the AMF 606 may be unable to verify the integrity of the information, or whether an attacker has tampered with this message.

Therefore, the AMF 606 may transmit a UE radio capability information Request message 612 to the NG-RAN node 604. According to an aspect of this disclosure, the AMF 606 may include the hash that it received from the UE 602 within the UE radio capability information Request message 612. And, in an example where the UE 602 included the random number (Nonce) in the Registration Request message, the AMF 606 may also include the random number in the UE radio capability information Request message 612.

By transmitting the UE radio capability information Request message 612, the AMF 606 initiates the UE Capability Enquiry procedure 614 between the NG-RAN node 604 and the UE 602, as described above and illustrated in FIG. 5. With this procedure 614, the NG-RAN node 604 may obtain the UE radio capability information from the UE 602. Although, in some examples, the UE Capability Enquiry procedure 614 in FIG. 6 may take place prior to the RAN node 604 receiving the UE radio capability information Request message 612.

The NG-RAN node 604 may then perform a radio capability verification procedure 616 to verify the integrity of the UE radio capability information initially sent by the UE 602 to the AMF 606. For example, the NG-RAN node 604 may calculate the hash of the UE radio capability information received from the UE 602 during the UE Capability Enquiry procedure 614. In an example where a random number is included in the hash procedure, the NG-RAN node 604 may include the random number it received from the AMF in message 612, above. Once the NG-RAN node 604 computes the hash, the NG-RAN node 604 may compare the computed hash with the received hash, which the NG-RAN node 604 received from the AMF 606 in message 612, above.

Here, if the comparison matches the computed hash with the received hash, then the NG-RAN node 604 may proceed with high confidence that the UE radio capabilities initially represented by the hash in message 610, above, have been verified. For example, the NG-RAN node 604 may set a UE radio capabilities verified flag to 1. In this way, the NG-RAN node 604 may explicitly indicate to the AMF 606 that it has successfully verified the UE radio capabilities, and hence, the AMF 606 may locally store the UE radio capabilities. Thus, the NG-RAN node 604 may transmit the UE radio capability information to the AMF 606 in a UE radio capability information Response message 618. On the other hand, if the comparison does not match, then the NG-RAN node 604 may inform the AMF 606 of the hash mismatch, and perform an error handling procedure. For example, the NG-RAN node 604 may release the RRC connection.

Once the AMF 606 receives the UE radio capabilities and the UE radio capability verified flag is set to 1, the AMF 606 may store the received UE radio capabilities and then continue with the remainder of the registration procedure 620. And furthermore, the UE radio capabilities and optionally, the UE radio capabilities verified flag can be sent to other network entities.

In a further aspect of the disclosure, it may be the case that the AMF 606 has already stored the UE radio capabilities information. That is, prior to the procedure illustrated in FIG. 6, the AMF 606 and UE 602 may have interacted in a way that the AMF 606 received and stored the UE radio capabilities information. In such a case, when the AMF 606 receives an initial NAS message that contains the hash of the UE radio capabilities, the AMF 606 may immediately check whether the received hash matches the stored UE radio capabilities. That is, the AMF 606 may immediately compute the hash of the stored UE radio capabilities and compare the computed hash with the received hash. Here, if the hash provided by the UE 602 matches with the stored UE radio capabilities, the procedure described above and illustrated in FIG. 6 may skip 612-618, and the registration procedure may proceed as normal. However, if the hash provided by the UE 602 does not match with the stored UE radio capabilities, then the AMF may trigger the UE capability enquiry procedure. That is, the process described above and illustrated in FIG. 6 may proceed, at message 612.

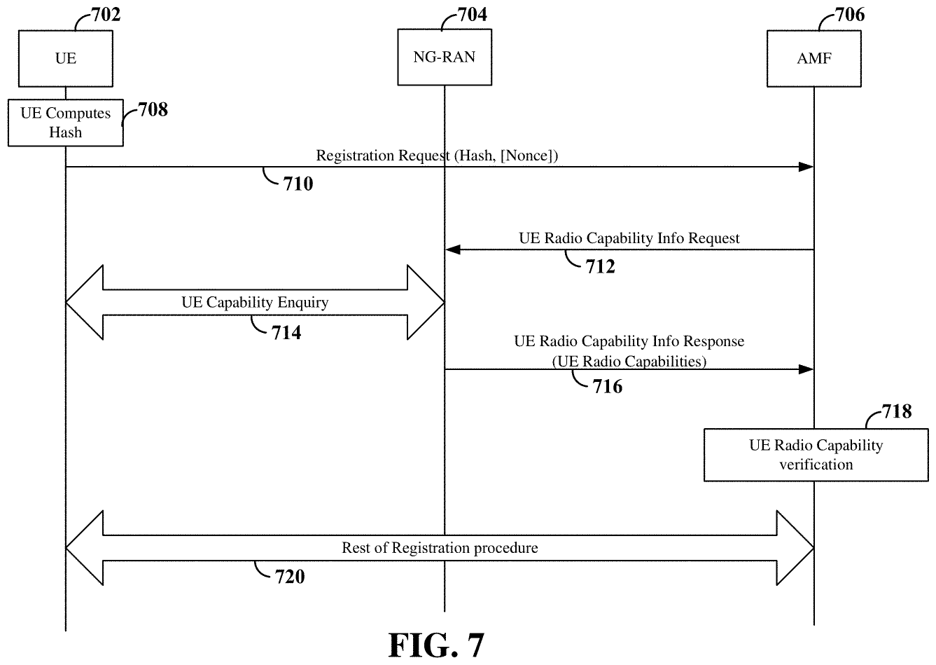

FIG. 7 is a call flow diagram illustrating another exemplary mechanism for protecting UE radio capability information according to some aspects. As in the example above illustrated in FIG. 6, a UE 702 may be a CP-only CIoT device in the general proximity of a NG-RAN node 704 communicatively coupled to a 5GC including an AMF 706. As with the prior example, it is to be understood that the disclosure that follows assumes the use of the 5G network, but the various aspects of this disclosure may be implemented in a E-UTRA network in an essentially equivalent manner, and the scope of this disclosure and the appended claims include such examples. In general, in such an E-UTRA example, the NG-RAN node 704 would be replaced with an eNB, and the AMF 706 would be replaced with an MME.

The call flow diagram may be initiated by the UE 702 performing a hash procedure 708 by which the UE 702 computes a hash of its UE radio capability information. The UE 702 may then transmit a Registration Request message 710, which the NG-RAN node 704 forwards to the AMF 706. As discussed above, the UE 702 may include the hash of the UE radio capability information within the Registration Request message 710. In a further aspect, the UE may include a random number along with the UE radio capability information when computing the hash. In an example where the random number is utilized in this manner in the hash calculation, the UE may transmit the random number along with the hash. This is represented in FIG. 7 by the optional [Nonce] included with the Hash in the Registration Request message 710, indicating the one-time random sequence.

In this example, the AMF 706 may not yet store the UE radio capability information of the UE 702. Therefore, the AMF 706 may be unable to verify the integrity of the information, or whether an attacker has tampered with this message.

Therefore, the AMF 706 may transmit a UE radio capability information

Request message 712 to the NG-RAN node 704. By transmitting the UE radio capability information Request message 712, the AMF 706 initiates the UE Capability Enquiry procedure 714 between the NG-RAN node 704 and the UE 702, as described above and illustrated in FIG. 5. With this procedure 714, the NG-RAN node 704 may obtain the UE radio capability information from the UE 702. Although, in some examples, the UE Capability Enquiry procedure 714 in FIG. 7 may take place prior to the RAN node 704 receiving the UE radio capability information Request message 712.

In response to the UE radio capability information Request message 712, the NG-RAN node 704 may transmit a UE radio capability information Response message 716 to the AMF 706. According to an aspect of this disclosure, the NG-RAN node 704 may include the UE radio capabilities information received from the UE 702 during the UE Capability Enquiry procedure 714 within the UE radio capability information Response 716. Accordingly, the AMF 706 may perform a UE radio capability verification procedure 718 to verify the integrity of the UE radio capability information initially sent by the UE 702 to the AMF 706. For example, the AMF may calculate the hash of the UE radio capability information received from the NG-RAN node 704 at message 716. In an example where a random number is included in the hash procedure 708, the AMF 706 may include the random number it received from the UE in message 710, above. Once the AMF 706 computes the hash, the AMF 706 may compare the computed hash with the received hash, which the AMF 706 received from the NG-RAN node 704 in message 710, above.

Here, if the comparison matches the computed hash with the received hash, then the AMF 706 may proceed with high confidence that the UE radio capabilities initially represented by the hash in message 710, above, have been verified. For example, the AMF 706 may set a UE radio capabilities verified flag to 1 and store the UE radio capabilities. Then, the AMF 706 may continue with the remainder of the registration procedure 720. And furthermore, the UE radio capabilities and optionally the UE radio capabilities verified flag can be sent to other network entities. If the comparison does not match the computed hash with the received hash, the AMF does not store the UE radio capabilities and may either request the NG-RAN node 704 retry the UE Capability Enquiry procedure 714 or may reject the UE registration request. In the latter case, the UE may retry registration.

In a further aspect of the disclosure, it may be the case that the AMF 706 has already stored the UE radio capabilities information. That is, prior to the procedure illustrated in FIG. 7, the AMF 706 and UE 702 may have interacted in a way that the AMF 706 received and stored the UE radio capabilities information. In such a case, when the AMF 706 receives an initial NAS message that contains the hash of the UE radio capabilities, the AMF 706 may immediately check whether the received hash matches the stored UE radio capabilities. That is, the AMF 706 may immediately compute the hash of the stored UE radio capabilities and compare the computed hash with the received hash. Here, if the hash provided by the UE 702 matches with the stored UE radio capabilities, the procedure described above and illustrated in FIG. 7 may skip 712-718, and the registration procedure 720 may proceed as normal. However, if the hash provided by the UE 702 does not match with the stored UE radio capabilities, then the AMF 706 may trigger the UE capability enquiry procedure 714. That is, the process described above and illustrated in FIG. 7 may proceed, at message 712.

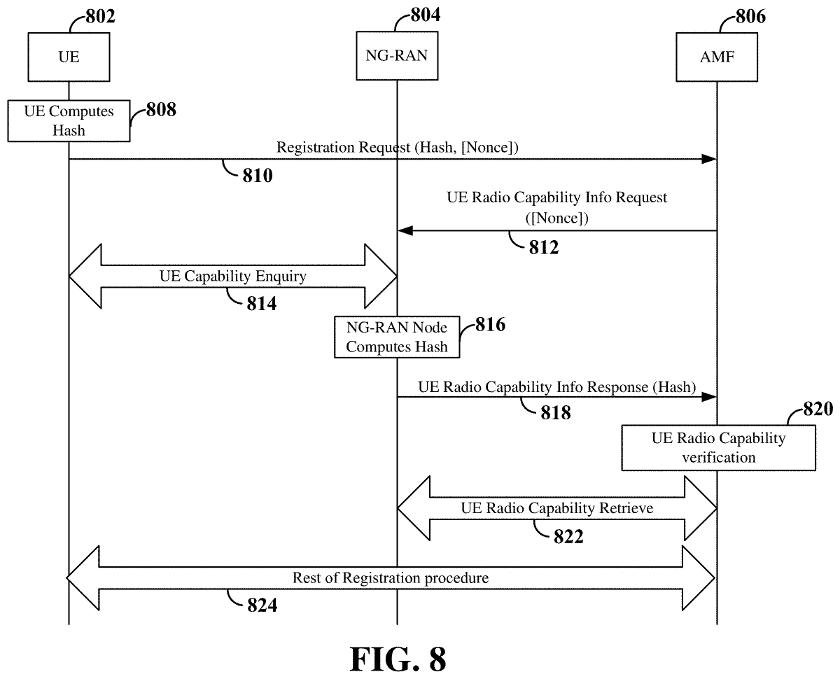

FIG. 8 is a call flow diagram illustrating another exemplary mechanism for protecting UE radio capability information according to some aspects, adapted to reduce or avoid the potentially unnecessary transfer of manipulated/invalid UE capabilities over the N2 interface (i.e., from NG-RAN node to AMF).

As in the examples above illustrated in FIGS. 6 and 7, a UE 802 may be a CP-only CIoT device in the general proximity of a NG-RAN node 804 communicatively coupled to a 5GC including an AMF 806. As with the prior examples, it is to be understood that the disclosure that follows assumes the use of the 5G network, but the various aspects of this disclosure may be implemented in a E-UTRA network in an essentially equivalent manner, and the scope of this disclosure and the appended claims include such examples. In general, in such an E-UTRA example, the NG-RAN node 804 would be replaced with an eNB, and the AMF 806 would be replaced with an MME.

The call flow diagram may be initiated by the UE 802 performing a hash procedure 808 by which the UE 802 computes a hash of its UE radio capability information. The UE 802 may then transmit a Registration Request message 810, which the NG-RAN node 804 forwards to the AMF 806. As discussed above, in an aspect of the present disclosure, the UE 802 may include the hash of the UE radio capability information within the Registration Request message 810. In a further aspect, the UE 802 may include a random number along with the UE radio capability information when computing the hash. In an example where the random number is utilized in this manner in the hash calculation, the UE 802 may transmit the random number along with the hash. This is represented in FIG. 8 by the optional [Nonce] included with the Hash in the Registration Request message 810, indicating the one-time random sequence.

In this example, the AMF 806 may not yet store the UE radio capability information of the UE 802. Therefore, the AMF 806 may be unable to verify the integrity of the information, or whether an attacker has tampered with this message.

Therefore, the AMF 806 may transmit a UE radio capability information Request message 812 to the NG-RAN node 804. By transmitting the UE radio capability information Request 812, the AMF 806 initiates the UE Capability Enquiry procedure 814 between the NG-RAN node 804 and the UE 802, as described above and illustrated in FIG. 5. With this procedure, the NG-RAN node 804 may obtain the UE radio capability information from the UE 802. And, in an example where a random number is utilized in the calculation of the hash, the AMF 806 may additionally include the random number in the UE radio capability information Request, as indicated by the [Nonce] in message 812. Although, in some examples, the UE Capability Enquiry procedure 814 in FIG. 8 may take place prior to the RAN node 804 receiving the UE radio capability information Request message 812.

At this point, when the NG-RAN node 804 has obtained UE radio capabilities based on AMF triggering the UE Capability Enquiry procedure 814, the NG-RAN node 804 computes the hash of the UE radio capabilities and provides the hash to the AMF 806. That is, the NG-RAN node 804 may compute the hash of the UE radio capability information received from the UE as part of the UE Capability Enquiry procedure 814 described above.

The NG-RAN node 804 may then transmit a UE radio capability information Response message 818 to the AMF 806. According to an aspect of this disclosure, the NG-RAN node 804 may include the hash of the UE radio capabilities information received from the UE 802 during the UE Capability Enquiry procedure 814 within the UE radio capability information Response 818. Accordingly, the AMF 806 may perform a UE radio capability verification procedure 820 to verify the integrity of the UE radio capability information initially sent by the UE 802 to the AMF 806. For example, the AMF 806 may compare the hash received from the UE 802 in message 810 with the received hash received from the NG-RAN node 804 in message 818.

Here, if the comparison matches the computed hash with the received hash, then the AMF 806 may retrieve the UE radio capabilities from the NG-RAN node. That is, the AMF 806 may employ a UE Radio Capability Retrieve procedure 822 to obtain this information from the NG-RAN node 804. The AMF 806 may then proceed with high confidence that the UE radio capabilities initially represented by the hash in message 810, above, have been verified. For example, the AMF 806 may set a UE radio capabilities verified flag, and the system may continue with the remainder of the registration procedure 824. And furthermore, the UE radio capabilities can be sent to other network entities. If the computed hash does not match the received hash, the AMF 806 may not obtain the UE radio capabilities from the NG-RAN node 804.

In a further aspect of the disclosure, it may be the case that the AMF 806 has already stored the UE radio capabilities information. That is, prior to the procedure illustrated in FIG. 8, the AMF 806 and UE 802 may have interacted in a way that the AMF 806 received and stored the UE radio capabilities information. In such a case, when the AMF 806 receives an initial NAS message that contains the hash of the UE radio capabilities, the AMF 806 may immediately check whether the received hash matches the stored UE radio capabilities. That is, the AMF 806 may immediately compute the hash of the stored UE radio capabilities and compare the computed hash with the received hash. Here, if the hash provided by the UE matches with the stored UE radio capabilities, the procedure described above and illustrated in FIG. 8 may skip 812-822, and the registration procedure may proceed as normal. However, if the hash provided by the UE does not match with the stored UE radio capabilities, then the AMF 806 may trigger the UE capability enquiry procedure 814. That is, the process described above and illustrated in FIG. 8 may proceed, at message 812.

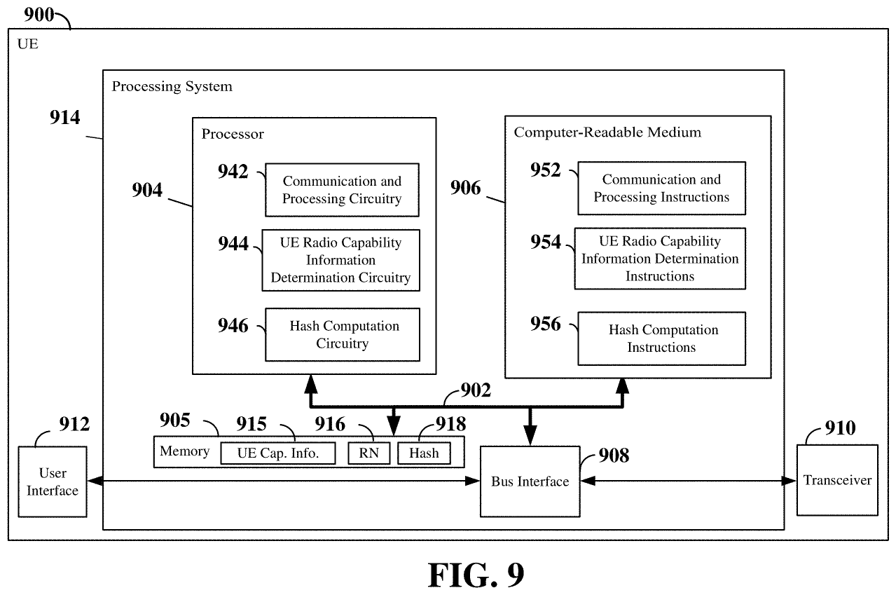

FIG. 9 is a block diagram illustrating an example of a hardware implementation for a UE 900 employing a processing system 914. For example, UE 900 may be the UE as illustrated in any one or more of FIGS. 1, 2, and/or 5-8. Further, the UE may be configured as a cellular internet-of-things (CIoT) device, described further below.

The UE 900 may be implemented with a processing system 914 that includes one or more processors 904. Examples of processors 904 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 900 may be configured to perform any one or more of the functions described herein. That is, the processor 904, as utilized in a UE 900, may be used to implement any one or more of the processes and procedures described herein.

The processor 904 may in some instances be implemented via a baseband or modem chip and in other implementations, the processor 904 may itself comprise a number of devices distinct and different from a baseband or modem chip (e.g., in such scenarios as may work in concert to achieve aspects discussed herein). And as mentioned above, various hardware arrangements and components outside of a baseband modem processor can be used in implementations, including RF-chains, power amplifiers, modulators, buffers, interleavers, adders/summers, etc.

In this example, the processing system 914 may be implemented with a bus architecture, represented generally by the bus 902. The bus 902 may include any number of interconnecting buses and bridges depending on the specific application of the processing system 914 and the overall design constraints. The bus 902 communicatively couples together various circuits including one or more processors (represented generally by the processor 904), a memory 905, and computer-readable media (represented generally by the computer-readable medium 906). The bus 902 may also link various other circuits such as timing sources, peripherals, voltage regulators, and power management circuits, which are well known in the art, and therefore, will not be described any further. A bus interface 908 provides an interface between the bus 902 and a transceiver 910. The transceiver 910 provides a communication interface or means for communicating with various other apparatus over a transmission medium. Depending upon the nature of the apparatus, a user interface 912 (e.g., keypad, display, speaker, microphone, joystick) may also be provided. Of course, such a user interface 912 is optional, and may be omitted in some examples.

The processor 904 is responsible for managing the bus 902 and general processing, including the execution of software stored on the computer-readable medium 906. The software, when executed by the processor 904, causes the processing system 914 to perform the various functions described below for any particular apparatus. The computer-readable medium 906 and the memory 905 may also be used for storing data that is manipulated by the processor 904 when executing software.

One or more processors 904 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 906.

The computer-readable medium 906 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 906 may reside in the processing system 914, external to the processing system 914, or distributed across multiple entities including the processing system 914. The computer-readable medium 906 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

In some aspects of the disclosure, the processor 904 may include circuitry configured for various functions. For example, the processor 904 may include communication and processing circuitry 942, configured to communicate with one or more radio access network (RAN) nodes, such as one or more base stations (e.g., gNBs, ng-eNBs, or other suitable NG-RAN nodes), and/or one or more scheduling entities. In some examples, the communication and processing circuitry 942 may include one or more hardware components that provide the physical structure that performs processes related to wireless communication (e.g., signal reception and/or signal transmission) and signal processing (e.g., processing a received signal and/or processing a signal for transmission).

In some examples, the communication and processing circuitry 942 may be configured to transmit a message to a core network node (e.g., an AMF or MME). In some examples, the message may include a NAS Registration Request or NAS Service Request. The message may further include a hash 918 of UE radio capability information (UE Cap. Info.) 915 associated with the UE 900. For example, the UE radio capability information 915 may indicate the radio capabilities of the UE. The message may further include a random number (RN) 916 used to compute the hash 918 of the UE radio capability information 915. The UE radio capability information 915, random number 916, and hash 918 of the UE radio capability information 915 may further be stored, for example, in memory 905.

The communication and processing circuitry 942 may further be configured to transmit the UE radio capability information 915 to a RAN node (e.g., a base station, such as a gNB, ng-eNB, or other NG-RAN node) during a UE capability enquiry procedure. In addition, the communication and processing circuitry 942 may be configured to perform a registration procedure with the core network node to register the UE 900 with the core network node. In addition, once registered, the communication and processing circuitry 942 may be configured to communicate data packets within RRC messages over a control plane between the UE 900 and the core network node. The communication and processing circuitry 942 may further be configured to execute communication and processing instructions (software) 952 stored in the computer-readable medium 906 to implement one or more of the functions described herein.

The processor 904 may further include UE radio capability information determination circuitry 944 configured for various functions, including, for example, determining the UE radio capability information 915 of the UE 900. For example, the UE radio capability information determination circuitry 944 may be configured to access the UE radio capability information 915 stored in the memory 905 to determine the UE radio capability information to be transmitted to the network. The UE radio capability information determination circuitry 944 may further be configured to execute UE radio capability information determination instructions (software) 954 stored in the computer-readable medium 906 to implement one or more of the functions described herein.

The processor 904 may further include hash computation circuitry 946 configured for various functions, including, for example, computing the hash 918 of the UE radio capability information 915. That is, the hash computation circuitry 946 may utilize any suitable hashing algorithm to transform the UE radio capability information 915 into a hash code 918 that represents the UE radio capability information 915. In some examples, the hash computation circuitry 946 may further be configured to generate the random number 916 using, for example, any suitable random or pseudo-random number generator algorithm. The hash computation circuitry 946 may then be configured to append the random number 916 (e.g., a random sequence) to the UE radio capability information 915 to produce a full sequence, and compute the hash 918 of the full sequence, including the UE radio capability information 915 and the random number 916. The hash computation circuitry 946 may further be configured to execute hash computing instructions (software) 956 stored in the computer-readable medium 906 to implement one or more of the functions described herein.

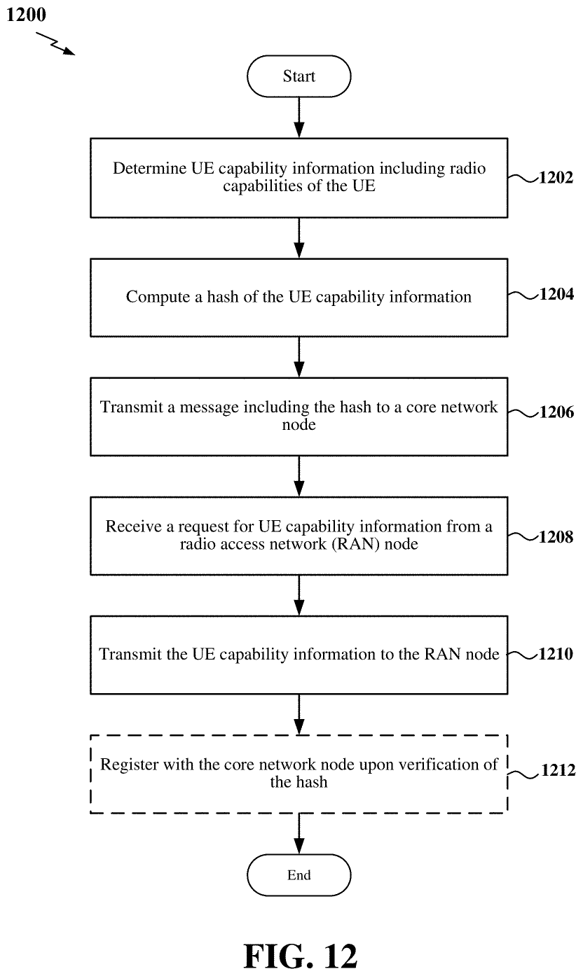

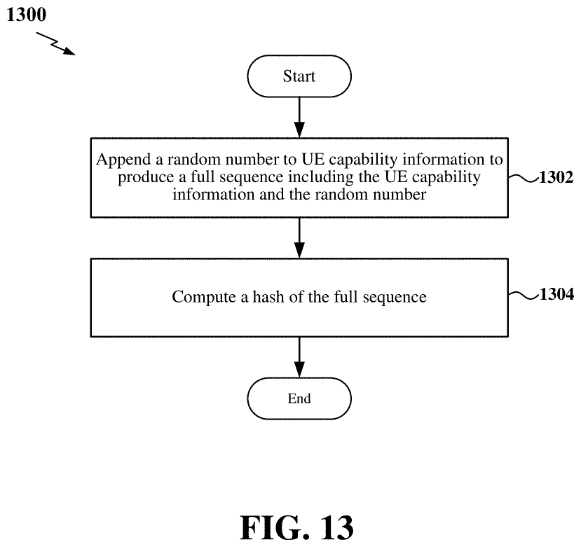

In one configuration, the UE 900 includes means for performing the various functions and processes described in relation to FIGS. 12 and 13 below. In one aspect, the aforementioned means may be the processor 904 shown in FIG. 9 configured to perform the functions recited by the aforementioned means. In another aspect, the aforementioned means may be a circuit or any apparatus configured to perform the functions recited by the aforementioned means.

Of course, in the above examples, the circuitry included in the processor 904 is merely provided as an example, and other means for carrying out the described functions may be included within various aspects of the present disclosure, including but not limited to the instructions stored in the computer-readable storage medium 906, or any other suitable apparatus or means described in any one of the FIGS. 1-8, and utilizing, for example, the processes and/or algorithms described herein in relation to FIGS. 12 and 13.

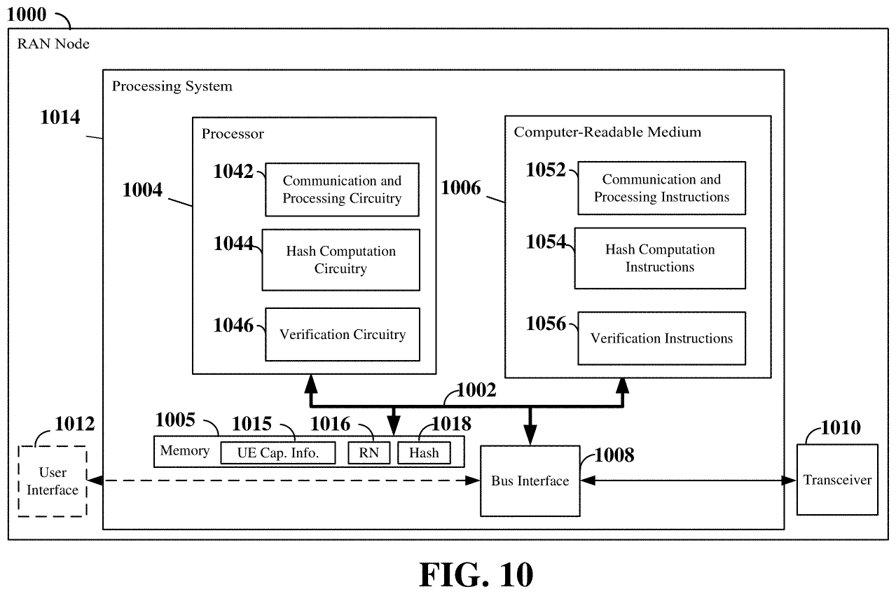

FIG. 10 is a conceptual diagram illustrating an example of a hardware implementation for an exemplary RAN node 1000 employing a processing system 1014. In accordance with various aspects of the disclosure, an element, or any portion of an element, or any combination of elements may be implemented with a processing system 1014 that includes one or more processors 1004. For example, the RAN node 1000 may be a base station, a gNB, an ng-eNB, and/or an eNB, as illustrated in any one or more of FIGS. 1-8.

The processing system 1014 may be substantially the same as the processing system 914 illustrated in FIG. 9, including a bus interface 1008, a bus 1002, memory 1005, a processor 1004, and a computer-readable medium 1006. Furthermore, the RAN node 1000 may include a user interface 1012 and a transceiver 1010 substantially similar to those described above in FIG. 9. That is, the processor 1004, as utilized in a RAN node 1000, may be used to implement any one or more of the processes and procedures described herein.

In some aspects of the disclosure, the processor 1004 may include circuitry configured for various functions. For example, the processor 1004 may include communication and processing circuitry 1042, configured to communicate with one or more UEs and/or scheduled entities and one or more core network nodes (e.g., AMF or MME). In some examples, the communication and processing circuitry 1042 may include one or more hardware components that provide the physical structure that performs processes related to wireless and backhaul communication (e.g., signal reception and/or signal transmission) and signal processing (e.g., processing a received signal and/or processing a signal for transmission).

In some examples, the communication and processing circuitry 1042 may be configured to forward a message from a UE to the core network node. In some examples, the message may include a NAS Registration Request or NAS Service Request. The message may further include a first hash 1018 of UE radio capability information (UE Cap. Info.) 1015 associated with the UE. For example, the UE radio capability information 1015 may indicate the radio capabilities of the UE. The message may further include a random number (RN) 1016 used to compute the hash 1018 of the UE radio capability information 1015.

The communication and processing circuitry 1042 may further be configured to receive the UE radio capability information 1015 from the UE during a UE capability enquiry procedure and to transmit the UE radio capability information 1015 to the core network node. For example, the communication and processing circuitry 1042 may be configured to receive a UE radio capability information request message from the core network node to initiate the UE capability enquiry procedure with the UE. In some examples, the UE radio capability information request may further include the first hash 1018 and the random number 1016 sent by the UE to the core network node. In other examples, the UE radio capability information request may include only the random number 1016. In addition, the communication and processing circuitry 1042 may be configured to transmit the received UE radio capability information 1015 to the core network node in a UE radio capability information response message. The UE radio capability information 1015, random number 1016, and first hash 1018 of the UE radio capability information 1015 may further be stored, for example, in memory 1005. The communication and processing circuitry 1042 may further be configured to execute communication and processing instructions (software) 1052 stored in the computer-readable medium 1006 to implement one or more of the functions described herein.

The processor 1004 may further include hash computation circuitry 1044 configured for various functions, including, for example, computing a second hash of the UE radio capability information 1015 received during the UE Capability Enquiry procedure. In an example where a random number is included in the hash procedure, the hash computation circuitry 1044 may include the random number received from the core network node in computing the second hash. For example, the hash computation circuitry 1044 may be configured to append the random number 1016 (e.g., a random sequence) to the UE radio capability information 1015 to produce a full sequence, and compute the hash 1018 of the full sequence, including the UE radio capability information 1015 and the random number 1016. In some examples, the hash computation circuitry 1044 may operate together with the communication and processing circuitry 1042 to transmit the second hash to the core network node. The hash computation circuitry 1044 may further be configured to execute hash computing instructions (software) 1054 stored in the computer-readable medium 1006 to implement one or more of the functions described herein.

The processor 1004 may further include verification circuitry 1046 configured for various functions, including, for example, verifying an integrity of the UE radio capability information 1015 received from the UE using the first hash 1018. In some examples, the verification circuitry 1046 may be configured to compare the first hash 1018 with the second hash computed by the hash computation circuitry 1044 to determine whether the first and second hash values match one another. The verification circuitry 1046 may be configured to successfully verify the integrity of the UE radio capability information 1015 when the second hash matches the first hash 1018. The verification circuitry 1046 may further be configured to set a UE radio capabilities verified flag to one and to include the UE radio capabilities verified flag in the UE radio capability information response message sent to the core network node.

The verification circuitry 1046 may further be configured to transmit a signal to the core network node indicating a hash mismatch when the first hash 1018 does not match the second hash. In addition, the verification circuitry 1046 may be configured to perform an error handling procedure when there is a hash mismatch. For example, the verification circuitry 1046 may be configured to instruct the communication and processing circuitry 1042 to release the RRC connection. The verification circuitry 1046 may further be configured to execute verification instructions (software) 1056 stored in the computer-readable medium 1006 to implement one or more of the functions described herein.

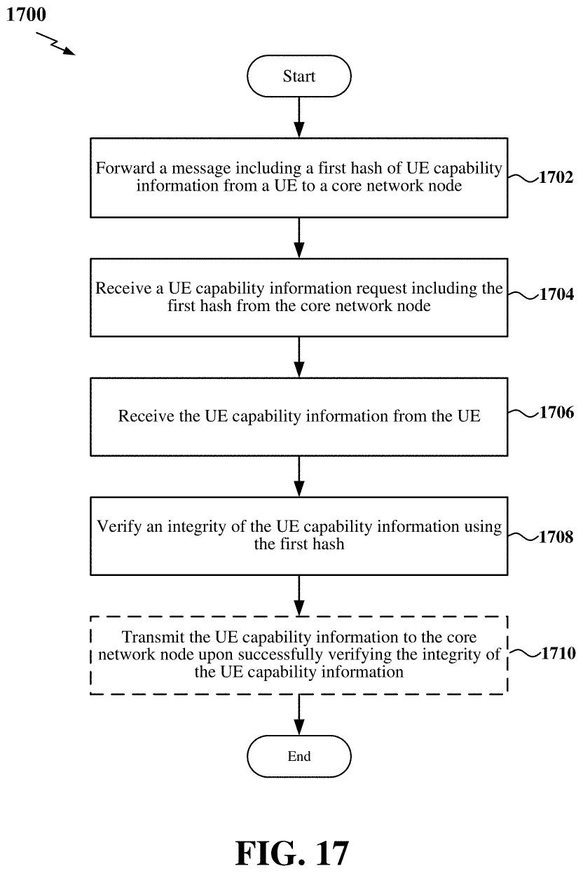

In one configuration, the RAN node 1000 includes means for performing the various functions and processes described in relation to FIGS. 17 and 10 below. In one aspect, the aforementioned means may be the processor 1004 shown in FIG. 10 configured to perform the functions recited by the aforementioned means. In another aspect, the aforementioned means may be a circuit or any apparatus configured to perform the functions recited by the aforementioned means.

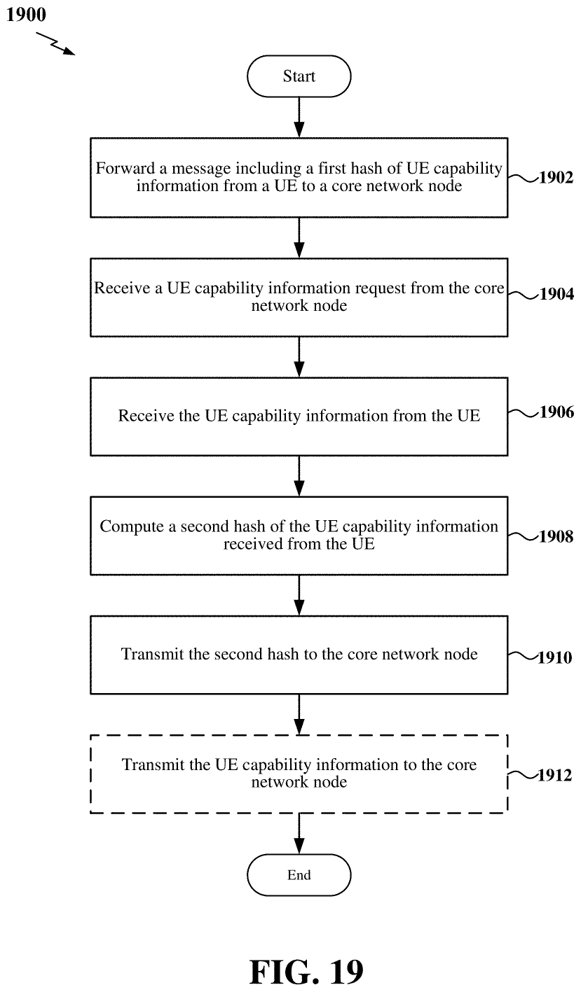

Of course, in the above examples, the circuitry included in the processor 1004 is merely provided as an example, and other means for carrying out the described functions may be included within various aspects of the present disclosure, including but not limited to the instructions stored in the computer-readable storage medium 1006, or any other suitable apparatus or means described in any one of the FIGS. 1-8, and utilizing, for example, the processes and/or algorithms described herein in relation to FIGS. 17 and 19.

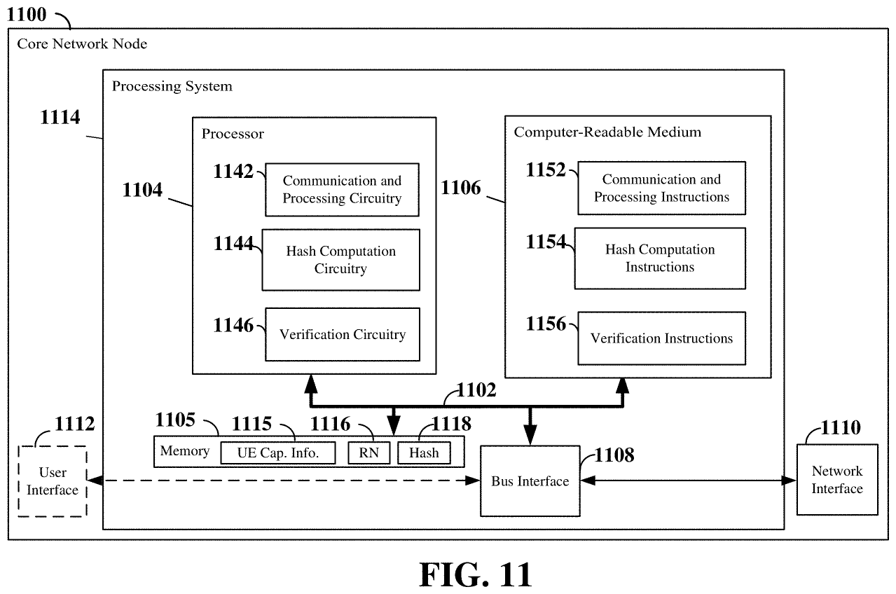

FIG. 11 is a conceptual diagram illustrating an example of a hardware implementation for an exemplary core network node 1100 employing a processing system 1114. In accordance with various aspects of the disclosure, an element, or any portion of an element, or any combination of elements may be implemented with a processing system 1114 that includes one or more processors 1104. For example, the core network node 1100 may be an AMF and/or an MME, as illustrated in any one or more of FIGS. 3,4, and/or 6-8.

The processing system 1114 may be substantially the same as the processing system 914 illustrated in FIG. 9, including a bus interface 1108, a bus 1102, memory 1105, a processor 1104, and a computer-readable medium 1106. Furthermore, the core network node 1100 may include a user interface 1112 substantially similar to that described above in FIG. 9. The core network node 1100 may further include a network interface 1110 that may provide a means for communicating over a core network and with one or more RAN nodes within a RAN. That is, the processor 1104, as utilized in a core network node 1100, may be used to implement any one or more of the processes and procedures described herein.

In some aspects of the disclosure, the processor 1104 may include communication and processing circuitry 1142, configured to communicate with one or more RAN entities (e.g., base stations, such as gNBs, ng-eNBs, or other NG-RAN nodes), one or more UEs via the one or more RAN entities, and one or more other core network nodes (e.g., UPF, SMF, etc.). In some examples, the communication and processing circuitry 1142 may include one or more hardware components that provide the physical structure that performs processes related to communication (e.g., signal reception and/or signal transmission) and signal processing (e.g., processing a received signal and/or processing a signal for transmission).

In some examples, the communication and processing circuitry 1142 may be configured to receive a message from a UE via a RAN node. In some examples, the message may include a NAS Registration Request or NAS Service Request. The message may further include a first hash 1118 of UE radio capability information (UE Cap. Info.) 1115 associated with the UE. For example, the UE radio capability information 1115 may indicate the radio capabilities of the UE. The message may further include a random number (RN) 1116 used to compute the hash 1118 of the UE radio capability information 1115.

The communication and processing circuitry 1142 may further be configured to transmit a UE radio capability information request message to the RAN node to initiate a UE capability enquiry procedure between the RAN node and the UE. In some examples, the UE radio capability information request may further include the first hash 1118 and the random number 1116 sent by the UE to the core network node 1100. In other examples, the UE radio capability information request may include only the random number 1116. In addition, the communication and processing circuitry 1142 may be configured to receive the UE radio capability information 1115 from the RAN node in a UE radio capability information response message. In some examples, the UE radio capability information response message may further include a UE radio capabilities verified flag set to one indicating that the RAN node verified the integrity of the UE radio capability information 1115. In some examples, the communication and processing circuitry 1142 may further be configured to receive a second hash from the RAN node computed by the RAN node based on the UE radio capability information received by the RAN node. The UE radio capability information 1115 (including the UE radio capabilities verified flag), random number 1116, and first hash 1118 of the UE radio capability information 1115 may further be stored, for example, in memory 1105.

The communication and processing circuitry 1142 may further be configured to perform a registration procedure with the UE to register the UE with the core network node 1100 upon receiving the NAS Registration Request. In addition, once registered, the communication and processing circuitry 1142 may be configured to communicate data packets within RRC messages over a control plane between the UE and the core network node 1100. The communication and processing circuitry 1142 may further be configured to execute communication and processing instructions (software) 1152 stored in the computer-readable medium 1106 to implement one or more of the functions described herein.

The processor 1104 may further include hash computation circuitry 1144 configured for various functions, including, for example, computing a second hash of the UE radio capability information 1115 received from the RAN node in the UE radio capability response message. In an example where a random number is included in the hash procedure, the hash computation circuitry 1144 may include the random number received from the UE in computing the second hash. For example, the hash computation circuitry 1144 may be configured to append the random number 1116 (e.g., a random sequence) to the UE radio capability information 1115 to produce a full sequence, and compute the hash 1118 of the full sequence, including the UE radio capability information 1115 and the random number 1116.

In examples in which the UE radio capability information 1115 is pre-stored, the hash computation circuitry 1144 may further be configured to compute a third hash of the pre-stored UE radio capability information. In some examples, the third hash may be computed using the random number received in the message from the UE. The hash computation circuitry 1144 may further be configured to execute hash computing instructions (software) 1154 stored in the computer-readable medium 1106 to implement one or more of the functions described herein.

The processor 1104 may further include verification circuitry 1146 configured for various functions, including, for example, verifying an integrity of the UE radio capability information 1115 using the first hash 1118. In some examples, the verification circuitry 1146 may be configured to compare the first hash 1118 with the second hash computed by the hash computation circuitry 1144 to determine whether the first and second hash values match one another. In other examples, the verification circuitry 1146 may be configured to compare the first hash 1118 with the second hash provided by the RAN node to determine whether the first and second hash values match one another. In either of these examples, the verification circuitry 1146 may be configured to successfully verify the integrity of the UE radio capability information 1115 when the second hash matches the first hash 1118. The verification circuitry 1146 may further be configured to set a UE radio capabilities verified flag to one when the second hash matches the first hash. In addition, the verification circuitry 1146 may be configured to register the UE upon successfully verifying the integrity of the UE radio capability information. The verification circuitry 1146 may further be configured to transmit a signal to the RAN node indicating a hash mismatch when the first hash 1118 does not match the second hash. In examples in which the second hash is received from the RAN node, the verification circuitry 1146 may further be configured to instruct the communication and processing circuitry 1142 to execute a UE Radio Capability Retrieve procedure to retrieve the UE radio capability information 1115 from the RAN node when the second hash matches the first hash.

In other examples, the verification circuitry 1146 may be configured to compare the first hash 1118 with the third hash computed by the hash computation circuitry 1144 based on pre-stored UE radio capability information 1115. In this example, the verification circuitry 1146 may be configured to instruct the communication and processing circuitry 1142 to transmit the UE radio capability information request to the RAN node when the first hash does not match the second hash. The verification circuitry 1146 may further be configured to execute verification instructions (software) 1156 stored in the computer-readable medium 1106 to implement one or more of the functions described herein.

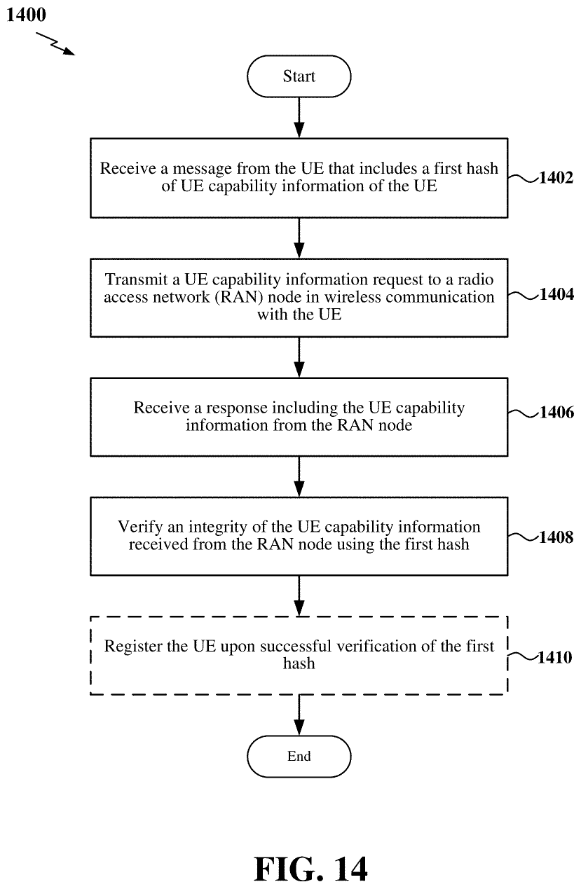

In one configuration, the core network node 1100 includes means for performing the various functions and processes described in relation to FIGS. 14-16, 18, and 20 below. In one aspect, the aforementioned means may be the processor 1104 shown in FIG. 11 configured to perform the functions recited by the aforementioned means. In another aspect, the aforementioned means may be a circuit or any apparatus configured to perform the functions recited by the aforementioned means.

Of course, in the above examples, the circuitry included in the processor 1104 is merely provided as an example, and other means for carrying out the described functions may be included within various aspects of the present disclosure, including but not limited to the instructions stored in the computer-readable storage medium 1106, or any other suitable apparatus or means described in any one of the FIGS. 1-8, and utilizing, for example, the processes and/or algorithms described herein in relation to FIGS. 14-16, 18, and 20.

FIG. 12 is a flow chart 1200 of an exemplary method for a UE to protect UE radio capability information according to some aspects. In some examples, the UE may be a CIoT device. As described below, some or all illustrated features may be omitted in a particular implementation within the scope of the present disclosure, and some illustrated features may not be required for implementation of all aspects. In some examples, the method may be performed by the UE 900, as described above and illustrated in FIG. 9, by a processor or processing system, or by any suitable means for carrying out the described functions.

At block 1202, the UE may determine UE radio capability information including radio capabilities of the UE. For example, the UE radio capability information determination circuitry 944 shown and described above in connection with FIG. 9 may provide a means to determine the UE radio capability information of the UE.

At block 1204, the UE may compute a hash of the UE radio capability information. For example, the UE may utilize any suitable hashing algorithm to transform the UE radio capability information into a hash code that represents the UE radio capability information. In some examples, the UE may compute a hash of a full sequence including a random number appended to the UE radio capability information. In this example, the UE may generate the random number using any suitable random number or pseudo-random number generator. In some examples, the random number is a one-time sequence. For example, the hash computation circuitry 946 shown and described above in connection with FIG. 9 may provide a means to compute the hash.

At block 1206, the UE may transmit a message including the hash to a core network node (e.g., an AMF or MME). For example, the message may include a non-access stratum (NAS) registration request or a NAS service request. In some examples, the message may include the hash and the random number. The message may be transmitted to the core network node via a radio access network (RAN) node (e.g., an NG-RAN node). For example, the communication and processing circuitry 942, together with the transceiver 910, shown and described above in connection with FIG. 9 may provide a means to transmit the message to the core network node.

At block 1208, the UE may receive a request for UE radio capability information from the RAN node. The request for UE radio capability information may be received as part of a UE Capability Enquiry procedure. For example, the communication and processing circuitry 942, together with the transceiver 910, shown and described above in connection with FIG. 9 may provide a means to receive the request for UE radio capability information.

At block 1210, the UE may transmit the UE radio capability information to the

RAN node. The UE radio capability information may be provided to the RAN node as part of the UE Capability Enquiry procedure. For example, the communication and processing circuitry 942, together with the transceiver 910, shown and described above in connection with FIG. 9 may provide a means to transmit the UE radio capability information to the RAN node.

At block 1212, the UE may optionally register with the core network node upon verification of the hash. For example, the UE may complete a registration procedure with the core network node upon the RAN node and/or the core network node verifying the hash. In some examples, the UE may then communicate data packets with the core network node within radio resource control (RRC) messages over a control plane between the UE and the core network node. For example, the communication and processing circuitry 942, together with the transceiver 910, shown and described above in connection with FIG. 9 may provide a means to register with the core network node.

FIG. 13 is a flow chart 1300 of an exemplary method for a UE to compute a hash of UE radio capability information according to some aspects. The method shown in FIG. 13 may correspond, for example, to block 1204 shown in FIG. 12. In some examples, the UE may be a CIoT device. As described below, some or all illustrated features may be omitted in a particular implementation within the scope of the present disclosure, and some illustrated features may not be required for implementation of all aspects. In some examples, the method may be performed by the UE 900, as described above and illustrated in FIG. 9, by a processor or processing system, or by any suitable means for carrying out the described functions.

At block 1302, the UE may append a random number to UE radio capability information to produce a full sequence including the UE radio capability information and the random number. In some examples, the UE may generate the random number using any suitable random number or pseudo-random number generator. In some examples, the random number is a one-time sequence. For example, the hash computation circuitry 946 shown and described above in connection with FIG. 9 may provide a means to append the random number to the UE radio capability information.

At block 1304, the UE may compute a hash of the full sequence. For example, the UE may utilize any suitable hashing algorithm to transform the full sequence, including the UE radio capability information and the random number, into a hash code that represents the full sequence. For example, the hash computation circuitry 946 shown and described above in connection with FIG. 9 may provide a means to compute the hash.

FIG. 14 is a flow chart 1400 of an exemplary method for a core network node to protect UE radio capability information according to some aspects. As described below, some or all illustrated features may be omitted in a particular implementation within the scope of the present disclosure, and some illustrated features may not be required for implementation of all aspects. In some examples, the method may be performed by the core network node 1100, as described above and illustrated in FIG. 11, by a processor or processing system, or by any suitable means for carrying out the described functions.

At block 1402, the core network node (e.g., an AMF or MME) may receive a message from a UE that includes a first hash of UE radio capability information of the UE. For example, the message may include a NAS registration request or a NAS service request. In some examples, the message may include the first hash and a random number utilized in computing the hash. For example, the first hash may include a full hash of the UE radio capability information and the random number appended to the UE radio capability information. In some examples, the random number includes a one-time sequence. The message may be received via a radio access network (RAN) node (e.g., an NG-RAN node) in wireless communication with the UE. For example, the communication and processing circuitry 1142, together with the network interface 1110, shown and described above in connection with FIG. 11 may provide a means to receive the message from the UE.

At block 1404, the core network node may transmit a UE radio capability information request to the RAN node in wireless communication with the UE. For example, the communication and processing circuitry 1142, together with the network interface 1110, shown and described above in connection with FIG. 11 may provide a means to transmit the UE radio capability information request to the RAN node.

At block 1406, the core network node may receive a response including the UE radio capability information from the RAN node. In some examples, the response may include a UE radio capability information response message. For example, the communication and processing circuitry 1142, together with the network interface 1110, may provide a means for receiving the response.

At block 1408, the core network node may verify an integrity of the UE radio capability information received from the RAN node using the first hash. In some examples, the core network node may compute a second hash of the UE radio capability information received from the RAN node. In examples in which the random number is received in the message at block 1402, the core network node may compute the second hash of the UE radio capability information and the random number appended to the UE radio capability information. The core network node may then verify the integrity of the UE radio capability information by comparing the first hash with the second hash. For example, the core network node may successfully verify the integrity of the UE radio capability information when the second hash matches the first hash. For example, the verification circuitry 1146, together with the hash computation circuitry 1144, shown and described above in connection with FIG. 11 may verify the integrity of the UE radio capability information.

At block 1410, the core network node may optionally register the UE upon successful verification of the first hash. For example, the communication and processing circuitry 1142 shown and described above in connection with FIG. 11 may provide a means to register the UE.

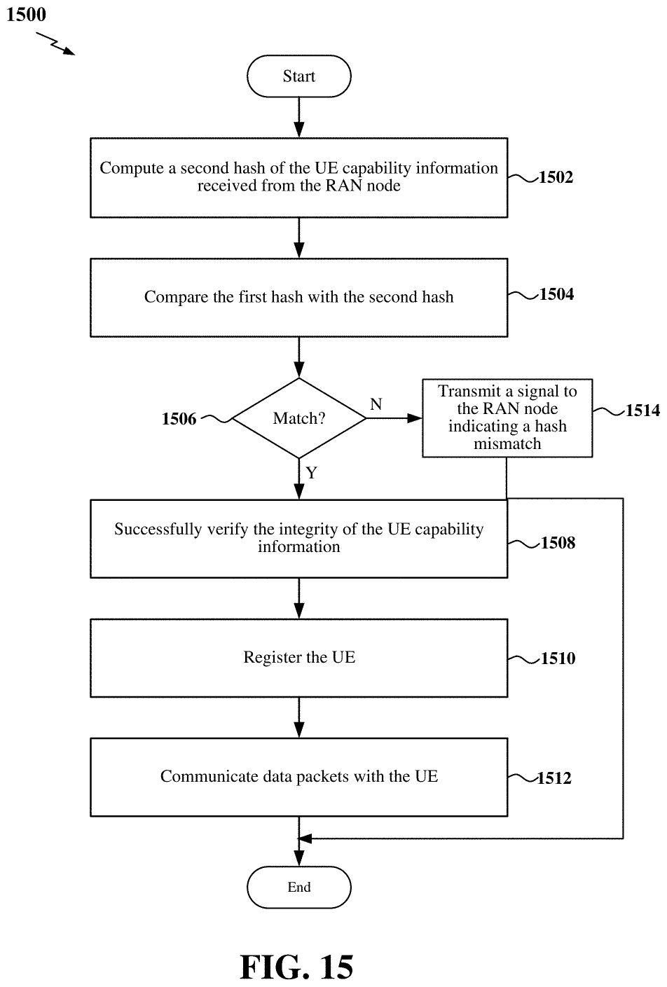

FIG. 15 is a flow chart 1500 of an exemplary method for a core network node to verify the integrity of UE radio capability information according to some aspects. The method shown in FIG. 15 may correspond, for example, to block 1408 shown in FIG. 14. As described below, some or all illustrated features may be omitted in a particular implementation within the scope of the present disclosure, and some illustrated features may not be required for implementation of all aspects. In some examples, the method may be performed by the core network node 1100, as described above and illustrated in FIG. 11, by a processor or processing system, or by any suitable means for carrying out the described functions.

At block 1502, the core network node (e.g., an AMF or MME) may compute a second hash of the UE radio capability information received from the RAN node. For example, the core network node may compute the second hash using the same hashing algorithm used by the UE to compute a first hash of the UE radio capability information. In examples in which the first hash includes a full hash of the UE radio capability information and a random number appended to the UE radio capability information, the core network node may compute the second hash of the UE radio capability information and the random number appended to the UE radio capability information. In some examples, the random number may include a one-time sequence. For example, the hash computation circuitry 1144 shown and described above in connection with FIG. 11 may provide a means to compute the second hash.

At block 1504, the core network node may compare the first hash with the second hash. For example, the verification circuitry 1146 shown and described above in connection with FIG. 11 may compare the first hash with the second hash.

At block 1506, the core network node may determine whether the first hash matches the second hash. If the first hash matches the second hash (Y branch of block 1506), at block 1508, the core network node may successfully verify the integrity of the UE radio capability information. In some examples, the core network node may set a UE radio capabilities verified flag to one when the first hash matches the second hash. For example, the verification circuitry 1146 shown and described above in connection with FIG. 11 may provide a means for determining whether the first hash matches the second hash. In addition, the verification circuitry 1146 may further provide a means for successfully verifying the integrity of the UE radio capability information when the first hash matches the second hash.

At block 1510, the core network node may register the UE upon successfully verifying the integrity of the UE radio capability information. For example, the core network node may complete a registration procedure for the UE. For example, the communication and processing circuitry 1142 shown and described above in connection with FIG. 11 may provide a means to register the UE.

At block 1512, the core network node may further communicate data packets with the UE upon registering the UE. In some examples, the UE may be a CIoT device, and the data packets may be communicated within RRC messages over a control plane between the UE and the core network node. For example, the communication and processing circuitry 1142 shown and described above in connection with FIG. 11 may provide a means to communicate data packets with the UE.

If the second hash does not match the first hash (N branch of block 1506), at block 1514, the core network node may transmit a signal to the RAN node indicating a hash mismatch. For example, the communication and processing circuitry 1142 shown and described above in connection with FIG. 11 may provide a means to transmit the signal indicating the hash mismatch to the RAN node.

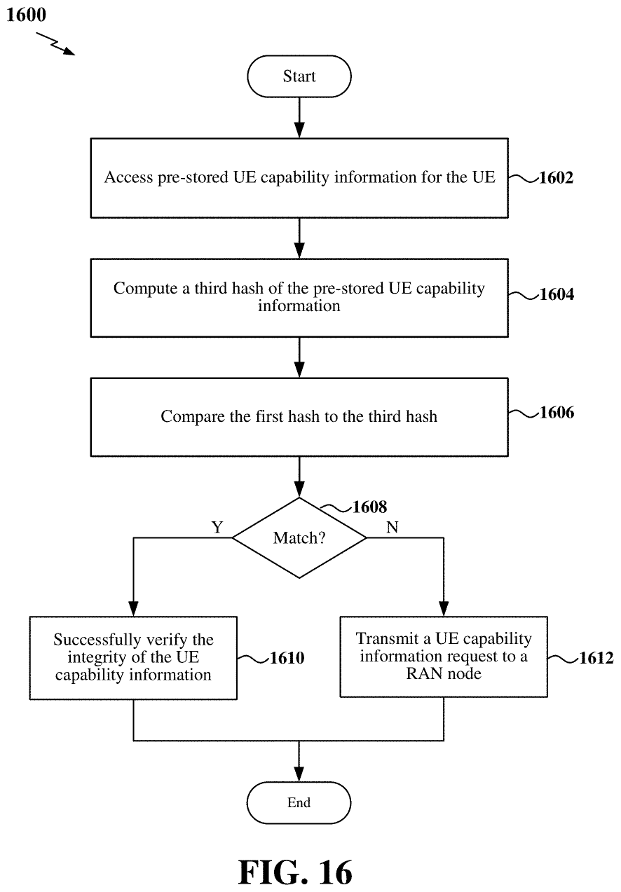

FIG. 16 is a flow chart 1600 of an exemplary method for a core network node to verify the integrity of pre-stored UE radio capability information according to some aspects. As described below, some or all illustrated features may be omitted in a particular implementation within the scope of the present disclosure, and some illustrated features may not be required for implementation of all aspects. In some examples, the method may be performed by the core network node 1100, as described above and illustrated in FIG. 11, by a processor or processing system, or by any suitable means for carrying out the described functions.

At block 1602, the core network node (e.g., AMF or MME) may access pre-stored UE radio capability information for the UE. For example, prior to the method illustrated in FIG. 14, the core network node and UE may have interacted in a way that the core network node received and stored the UE radio capability information. For example, the hash computation circuitry 1144 shown and described above in connection with FIG. 11 may provide a means to access the pre-stored UE radio capability information.

At block 1604, the core network node may compute a third hash of the pre-stored UE radio capability information. For example, the core network node may compute the third hash using the same hashing algorithm used by the UE to compute a first hash of the UE radio capability information. In examples in which the first hash includes a full hash of the UE radio capability information and a random number appended to the UE radio capability information, the core network node may compute the second hash of the UE radio capability information and the random number appended to the UE radio capability information. Therefore, in some examples, block 1604 may be performed after receipt of the message including the first hash at block 1402 of FIG. 14. For example, the hash computation circuitry 1144 shown and described above in connection with FIG. 11 may provide a means to compute the third hash.

At block 1606, the core network node may compare the first hash to the third hash. For example, the verification circuitry 1146 shown and described above in connection with FIG. 11 may compare the first hash with the third hash.

At block 1608, the core network node may determine whether the first hash matches the third hash. If the first hash matches the third hash (Y branch of block 1608), at block 1610, the core network node may successfully verify the integrity of the UE radio capability information. In some examples, the core network node may set a UE radio capabilities verified flag to one when the first hash matches the second hash. For example, the verification circuitry 1146 shown and described above in connection with FIG. 11 may provide a means for determining whether the first hash matches the third hash. In addition, the verification circuitry 1146 may further provide a means for successfully verifying the integrity of the UE radio capability information when the first hash matches the third hash.

If the first hash does not match the second hash (N branch of block 1608), at block 1612, the core network node may transmit a UE radio capability information request to a RAN node in wireless communication with the UE. For example, block 1612 may correspond to block 1404 of FIG. 14. For example, the communication and processing circuitry 1142, together with the network interface 1110, shown and described above in connection with FIG. 11 may provide a means to transmit the UE radio capability information request to the RAN node.

FIG. 17 is a flow chart 1700 of an exemplary method for a RAN node to protect UE radio capability information according to some aspects. As described below, some or all illustrated features may be omitted in a particular implementation within the scope of the present disclosure, and some illustrated features may not be required for implementation of all aspects. In some examples, the method may be performed by the RAN node 1000, as described above and illustrated in FIG. 10, by a processor or processing system, or by any suitable means for carrying out the described functions.

At block 1702, the RAN node (e.g., a base station, such as a gNB, ng-eNB, or other NG-RAN node) may forward a message including a first hash of UE radio capability information from a UE to a core network node (e.g., an AMF or MME). In some examples, the first hash includes a full hash of the UE radio capability information and a random number appended to the UE radio capability information. In this example, the message may further include the random number. In some examples, the message may include a NAS registration request or a NAS service request. For example, the communication and processing circuitry 1042 shown and described above in connection with FIG. 10 may provide a means to forward the message from the UE to the core network node.

At block 1704, the RAN node may receive a UE radio capability information request including the first hash from the core network node. In examples in which the first hash includes the full hash of the UE radio capability information and the random number appended to the UE radio capability information, the UE radio capability information request may further include the random number. For example, the communication and processing circuitry 1042 shown and described above in connection with FIG. 10 may provide a means to receive the UE radio capability information.

At block 1706, the RAN node may receive the UE radio capability information from the UE. For example, the RAN node may receive the UE radio capability information during a UE Capability Enquiry procedure. For example, the communication and processing circuitry 1042 shown and described above in connection with FIG. 10 may provide a means to receive the UE radio capability information from the UE.

At block 1708, the RAN node may verify an integrity of the UE radio capability information using the first hash. In some examples, the RAN node may compute a second hash of the UE radio capability information received from the UE. In examples in which the random number is included in the UE radio capability information request, the RAN node may compute the second hash of the UE radio capability information and the random number appended to the UE radio capability information. The RAN node may then compare the first hash with the second hash. The RAN node may then successfully verify the integrity of the UE radio capability information when the second hash matches the first hash. When the first hash does not match the second hash, the RAN node may transmit a signal to the core network node indicating a hash mismatch. The RAN node may further release an RRC connection with the UE when the first hash does not match the second hash. For example, the verification circuitry 1046, together with the hash computation circuitry 1044, shown and described above in connection with FIG. 10 may provide a means to verify the integrity of the UE radio capability information.

At block 1710, the RAN node may optionally transmit the UE radio capability information to the core network node upon successfully verifying the integrity of the UE radio capability information. In some examples, the RAN node may set a UE radio capabilities verified flag to one when the first hash matches the second hash and include the UE radio capabilities verified flag within the UE radio capability information transmitted to the core network node. For example, the communication and processing circuitry 1042, together with the transceiver 1010, shown and described above in connection with FIG. 10 may provide a means for transmitting the UE radio capability information to the core network node.

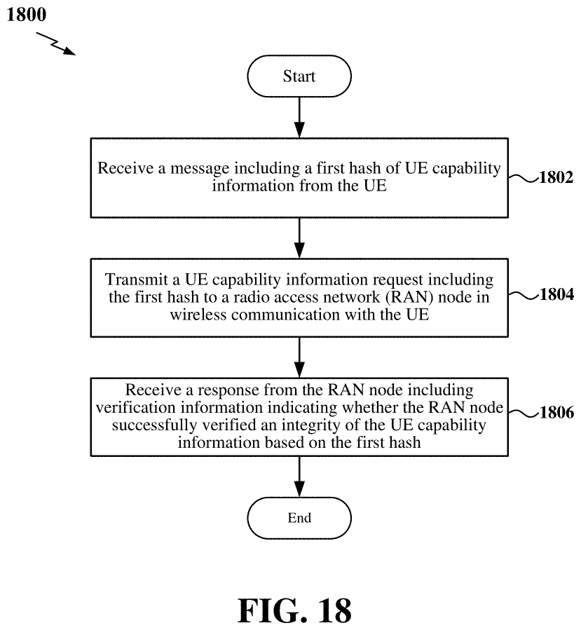

FIG. 18 is a flow chart 1800 of another exemplary method for a core network node to protect UE radio capability information according to some aspects. As described below, some or all illustrated features may be omitted in a particular implementation within the scope of the present disclosure, and some illustrated features may not be required for implementation of all aspects. In some examples, the method may be performed by the core network node 1100, as described above and illustrated in FIG. 11, by a processor or processing system, or by any suitable means for carrying out the described functions.

At block 1802, the core network node (e.g., an AMF or MME) may receive a message including a first hash of UE radio capability information from the UE. For example, the message may include a NAS registration request or a NAS service request. In some examples, the message may include the first hash and a random number utilized in computing the hash. For example, the first hash may include a full hash of the UE radio capability information and the random number appended to the UE radio capability information. In some examples, the random number includes a one-time sequence. The message may be received via a radio access network (RAN) node (e.g., an NG-RAN node) in wireless communication with the UE. For example, the communication and processing circuitry 1142, together with the network interface 1110, shown and described above in connection with FIG. 11 may provide a means to receive the message from the UE.

At block 1804, the core network node may transmit a UE radio capability information request including the first hash to the RAN node. In examples in which the message includes the random number, the UE radio capability information request may further include the random number. In some examples, the core network node may perform the method shown in FIG. 16 prior to transmitting the UE radio capability information request. For example, the communication and processing circuitry 1142, together with the network interface 1110, shown and described above in connection with FIG. 11 may provide a means for transmitting the UE radio capability information request.

At block 1806, the core network node may receive a response from the RAN node including verification information indicating whether the RAN node successfully verified an integrity of the UE radio capability information based on the first hash. In some examples, the response includes the UE radio capability information when the verification information indicates that the RAN node successfully verified the integrity of the UE radio capability information. In some examples, the verification information includes a UE radio capabilities verified flag set to one. In some examples, the verification information comprises a signal indicating that verification of the integrity of the UE radio capability information by the RAN node was not successful. For example, the communication and processing circuitry 1142, together with the network interface 1110, shown and described above in connection with FIG. 11 may provide a means for receiving the response from the RAN node.

FIG. 19 is a flow chart 1900 of another exemplary method for a RAN node to protect UE radio capability information according to some aspects. As described below, some or all illustrated features may be omitted in a particular implementation within the scope of the present disclosure, and some illustrated features may not be required for implementation of all aspects. In some examples, the method may be performed by the RAN node 1000, as described above and illustrated in FIG. 10, by a processor or processing system, or by any suitable means for carrying out the described functions.

At block 1902, the RAN node (e.g., a base station, such as a gNB, ng-eNB, or other NG-RAN node) may forward a message including a first hash of UE radio capability information from a UE to a core network node (e.g., an AMF or MME). In some examples, the first hash includes a full hash of the UE radio capability information and a random number appended to the UE radio capability information. In this example, the message may further include the random number. In some examples, the message may include a NAS registration request or a NAS service request. For example, the communication and processing circuitry 1042 shown and described above in connection with FIG. 10 may provide a means to forward the message from the UE to the core network node.

At block 1904, the RAN node may receive a UE radio capability information request from the core network node. In examples in which the first hash includes the full hash of the UE radio capability information and the random number appended to the UE radio capability information, the UE radio capability information request may include the random number. For example, the communication and processing circuitry 1042 shown and described above in connection with FIG. 10 may provide a means to receive the UE radio capability information.

At block 1906, the RAN node may receive the UE radio capability information from the UE. For example, the RAN node may receive the UE radio capability information during a UE Capability Enquiry procedure. For example, the communication and processing circuitry 1042 shown and described above in connection with FIG. 10 may provide a means to receive the UE radio capability information from the UE.

At block 1908, the RAN node may compute a second hash of the UE radio capability information received from the UE. In examples in which the random number is included in the UE radio capability information request, the RAN node may compute the second hash of the UE radio capability information and the random number appended to the UE radio capability information. For example, the hash computation circuitry 1044 shown and described above in connection with FIG. 10 may provide a means to compute the second hash.

At block 1910, the RAN node may transmit the second hash to the core network node. For example, the communication and processing circuitry 1042, together with the transceiver 1010, shown and described above in connection with FIG. 10 may provide a means for transmitting the second hash to the core network node.

At block 1912, the RAN node may optionally transmit the UE radio capability information to the core network node. For example, the RAN node may transmit the UE radio capability information during a UE radio capability retrieve procedure performed upon successful verification of the integrity of the UE radio capability information using the first and second hashes by the core network node. For example, the communication and processing circuitry 1042, together with the transceiver 1010, shown and described above in connection with FIG. 10 may provide a means to transmit the UE radio capability information to the core network node.

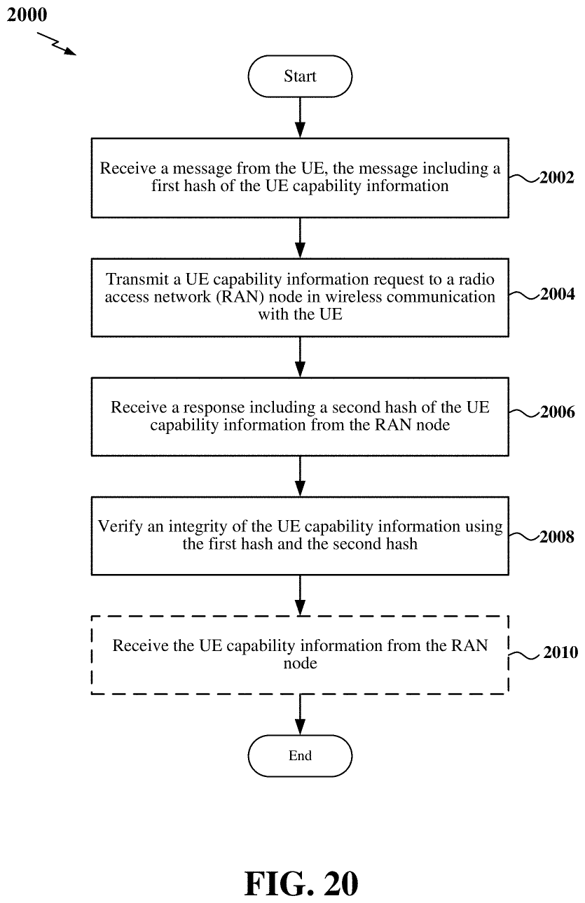

FIG. 20 is a flow chart of another exemplary method for a core network node to protect UE radio capability information according to some aspects. As described below, some or all illustrated features may be omitted in a particular implementation within the scope of the present disclosure, and some illustrated features may not be required for implementation of all aspects. In some examples, the method may be performed by the core network node 1100, as described above and illustrated in FIG. 11, by a processor or processing system, or by any suitable means for carrying out the described functions.

At block 2002, the core network node (e.g., an AMF or MME) may receive a message including a first hash of UE radio capability information from the UE. For example, the message may include a NAS registration request or a NAS service request. In some examples, the message may include the first hash and a random number utilized in computing the hash. For example, the first hash may include a full hash of the UE radio capability information and the random number appended to the UE radio capability information. In some examples, the random number includes a one-time sequence. The message may be received via a radio access network (RAN) node (e.g., an NG-RAN node) in wireless communication with the UE. For example, the communication and processing circuitry 1142, together with the network interface 1110, shown and described above in connection with FIG. 11 may provide a means to receive the message from the UE.

At block 2004, the core network node may transmit a UE radio capability information request including the first hash to the RAN node. In examples in which the message includes the random number, the UE radio capability information request may further include the random number. In some examples, the core network node may perform the method shown in FIG. 16 prior to transmitting the UE radio capability information request. For example, the communication and processing circuitry 1142, together with the network interface 1110, shown and described above in connection with FIG. 11 may provide a means for transmitting the UE radio capability information request.

At block 2006, the core network node may receive a response including a second hash of the UE radio capability information from the RAN node. For example, the communication and processing circuitry 1142, together with the network interface 1110, shown and described above in connection with FIG. 11 may provide a means for receiving the response from the RAN node.

At block 2008, the core network node may verify an integrity of the UE radio capability information using the first hash and the second hash. For example, the core network node may compare the first hash with the second hash. The core network node may then determine whether the first hash matches the second hash. If the first hash matches the second hash, the core network node may successfully verify the integrity of the UE radio capability information. In some examples, the core network node may set a UE radio capabilities verified flag to one when the first hash matches the second hash. For example, the verification circuitry 1146 shown and described above in connection with FIG. 11 may provide a means for verifying the integrity of the UE radio capability information.

At block 2010, the core network node may optionally receive the UE radio capability information from the RAN node. For example, the core network node may receive the UE radio capability information from the RAN node during a UE radio capability retrieve procedure performed upon successful verification of the integrity of the UE radio capability information using the first and second hashes by the core network node. The core network node may then register the UE (e.g., by completing a registration procedure with the UE). For example, the communication and processing circuitry 1142, together with the network interface 1110, shown and described above in connection with FIG. 11 may provide a means to receive the UE radio capability information from the RAN node.

The processes shown in FIGS. 12-20 may include additional aspects, such as any single aspect or any combination of aspects described below and/or in connection with one or more other processes described elsewhere herein.

In a first aspect, a user equipment (UE) may determine UE radio capability information including radio capabilities of the UE, compute a hash of the UE radio capability information, and transmit a message to a core network node. The message can include the hash. The UE may further receive a request for UE radio capability information from a radio access network (RAN) node, and transmit the UE radio capability information to the RAN node.

In a second aspect, alone or in combination with the first aspect, the UE may register with the core network node upon verification of the hash.

In a third aspect, alone or in combination with one or more of the first aspect and the second aspect, the UE may communicate data packets within radio resource control (RRC) messages over a control plane between the UE and the core network node.

In a fourth aspect, alone or in combination with one or more of the first through third aspects, the UE may transmit the message to the core network node via the RAN node.

In a fifth aspect, alone or in combination with one or more of the first through fourth aspects, the UE may append a random number to the UE radio capability information to produce a full sequence including the UE radio capability information and the random number, and compute the hash of the full sequence.

In a sixth aspect, alone or in combination with one or more of the first through fifth aspects, the UE may transmit the message including the hash and the random number to the core network node.

In a seventh aspect, alone or in combination with one or more of the first through sixth aspects, the random number may include a one-time sequence.

In an eighth aspect, alone or in combination with one or more of the first through seventh aspects, the UE message may include a non-access stratum (NAS) registration request or a NAS service request.

In a ninth aspect, alone or in combination with one or more of the first through eighth aspects, the UE may include a cellular internet-of-things (CIoT) device.

In a tenth aspect, a core network node may receive a message from the UE. The message may include a first hash of the UE radio capability information. The core network node may further transmit a UE radio capability information request to a radio access network (RAN) node in wireless communication with the UE, receive a response from the RAN node, the response including the UE radio capability information, and verify an integrity of the UE radio capability information received from the RAN node using the first hash.

In an eleventh aspect, alone or in combination with the tenth aspect, the core network node may compute a second hash of the UE radio capability information received from the RAN node, compare the first hash with the second hash, and successfully verify the integrity of the UE radio capability information when the second hash matches the first hash.

In a twelfth aspect, alone or in combination with any one or more of the tenth aspect and the eleventh aspect, the core network node may register the UE upon successfully verifying the integrity of the UE radio capability information.

In a thirteenth aspect, alone or in combination with any one or more of the tenth through twelfth aspects, the core network node may communicate data packets within radio resource control (RRC) messages over a control plane between the UE and the core network node.

In a fourteenth aspect, alone or in combination with any one or more of the tenth through thirteenth aspects, the core network node may transmit a signal to the RAN node indicating a hash mismatch when the first hash does not match the second hash.

In a fifteenth aspect, alone or in combination with any one or more of the tenth through fourteenth aspects, the message further includes a random number and the first hash includes a full hash of the UE radio capability information and the random number appended to the UE radio capability information. The core network node may further compute the second hash of the UE radio capability information and the random number appended to the UE radio capability information.

In a sixteenth aspect, alone or in combination with one or more of the tenth through fifteenth aspects, the random number may include a one-time sequence.

In a seventeenth aspect, alone or in combination with one or more of the tenth through sixteenth aspects, the core network node may set a UE radio capabilities verified flag to one when the first hash matches the second hash.

In an eighteenth aspect, alone or in combination with one or more of the tenth through seventeenth aspects, the core network node may access pre-stored UE radio capability information for the UE, compute a third hash of the pre-stored UE radio capability information, compare the first hash to the third hash, and transmit the UE radio capability information request to the RAN node when the first hash does not match the third hash.

In a nineteenth aspect, alone or in combination with one or more of the tenth through eighteenth aspects, the message may include a non-access stratum (NAS) registration request or a NAS service request.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-20 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1-11 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

What is claimed is:

1. A method for wireless communication at a user equipment (UE), the method comprising:
determining UE radio capability information comprising radio capabilities of the UE;
computing a hash of the UE radio capability information;
transmitting a message to a core network node, the message comprising the hash;
receiving a request for UE radio capability information from a radio access network (RAN) node; and
transmitting the UE radio capability information to the RAN node.

2. The method of claim 1, further comprising:
registering with the core network node upon verification of the hash.

3. The method of claim 2, further comprising:
communicating data packets within radio resource control (RRC) messages over a control plane between the UE and the core network node.

4. The method of claim 1, wherein the transmitting the message to the core network node further comprises:
transmitting the message to the core network node via the RAN node.

5. The method of claim 1, wherein the computing the hash comprises:
appending a random number to the UE radio capability information to produce a full sequence comprising the UE radio capability information and the random number; and
computing the hash of the full sequence.

6. The method of claim 5, wherein the transmitting the message to the core network node further comprises:
transmitting the message comprising the hash and the random number to the core network node.

7. The method of claim 5, wherein the random number comprises a one-time sequence.

8. The method of claim 1, wherein the message comprises a non-access stratum (NAS) registration request or a NAS service request.

9. The method of claim 1, wherein the UE comprises a cellular internet-of-things (CIoT) device.

10. A method for a core network node to receive user equipment (UE) capability information, the method comprising:
receiving a message from the UE, the message comprising a first hash of the UE radio capability information;
transmitting a UE radio capability information request to a radio access network (RAN) node in wireless communication with the UE;
receiving a response from the RAN node, the response comprising the UE radio capability information; and
verifying an integrity of the UE radio capability information received from the RAN node using the first hash.

11. The method of claim 10, wherein the verifying the integrity of the UE radio capability information comprises:
computing a second hash of the UE radio capability information received from the RAN node;
comparing the first hash with the second hash; and
successfully verifying the integrity of the UE radio capability information when the second hash matches the first hash.

12. The method of claim 11, further comprising:
registering the UE upon successfully verifying the integrity of the UE radio capability information.

13. The method of claim 12, further comprising:
communicating data packets within radio resource control (RRC) messages over a control plane between the UE and the core network node.

14. The method of claim 11, further comprising:
transmitting a signal to the RAN node indicating a hash mismatch when the first hash does not match the second hash.

15. The method of claim 11, wherein the message further comprises a random number and the first hash comprises a full hash of the UE radio capability information and the random number appended to the UE radio capability information, and wherein the computing the second hash further comprises:
computing the second hash of the UE radio capability information and the random number appended to the UE radio capability information.

16. The method of claim 15, wherein the random number comprises a one-time sequence.

17. The method of claim 11, further comprising:
setting a UE radio capabilities verified flag to one when the first hash matches the second hash.

18. The method of claim 10, wherein the transmitting the UE radio capability information request to the RAN node comprises:
accessing pre-stored UE radio capability information for the UE;
computing a third hash of the pre-stored UE radio capability information;
comparing the first hash to the third hash; and
transmitting the UE radio capability information request to the RAN node when the first hash does not match the third hash.

19. The method of claim 10, wherein the message comprises a non-access stratum (NAS) registration request or a NAS service request.

20. A user equipment (UE) configured for wireless communication, comprising:
a transceiver configured to communicate over a wireless link with a radio access network (RAN) node;
a memory; and
a processor coupled to the transceiver and the memory, wherein the processor and the memory are configured to:
determine UE radio capability information comprising radio capabilities of the UE;
compute a hash of the UE radio capability information;
transmit a message to a core network node via the transceiver, the message comprising the hash;
receive a request for UE radio capability information from the RAN node; and
transmit the UE radio capability information to the RAN node via the transceiver.

21. The UE of claim 10, wherein the processor and the memory are further configured to:
register with the core network node upon verification of the hash; and
communicate data packets within radio resource control (RRC) messages over a control plane between the UE and the core network node.

22. The UE of claim 20, wherein the processor and the memory are further configured to:
append a random number to the UE radio capability information to produce a full sequence comprising the UE radio capability information and the random number; and
compute the hash of the full sequence.

23. The UE of claim 22, wherein the processor and the memory are further configured to:
transmit the message comprising the hash and the random number to the core network node.

24. A core network node within a core network, comprising:
a network interface;
a memory; and
a processor coupled to the network interface and the memory, wherein the processor and the memory are configured to:
receive a message from the UE via the network interface, the message comprising a first hash of the UE radio capability information;
transmit a UE radio capability information request to a radio access network (RAN) node in wireless communication with the UE via the network interface;
receive a response from the RAN node via the network interface, the response comprising the UE radio capability information; and
verify an integrity of the UE radio capability information received from the RAN node using the first hash.

25. The core network node of claim 24, wherein the processor and the memory are further configured to:
compute a second hash of the UE radio capability information received from the RAN node;
compare the first hash with the second hash; and
successfully verify the integrity of the UE radio capability information when the second hash matches the first hash.

26. The core network node of claim 25, wherein the processor and the memory are further configured to:
register the UE upon successfully verifying the integrity of the UE radio capability information; and
communicate data packets within radio resource control (RRC) messages over a control plane between the UE and the core network node.

27. The core network node of claim 25, wherein the processor and the memory are further configured to:
transmit a signal to the RAN node indicating a hash mismatch when the first hash does not match the second hash.

28. The core network node of claim 25, wherein the message further comprises a random number and the first hash comprises a full hash of the UE radio capability information and the random number appended to the UE radio capability information, and wherein the processor and the memory are further configured to:
compute the second hash of the UE radio capability information and the random number appended to the UE radio capability information.

29. The core network node of claim 25, wherein the processor and the memory are further configured to:
set a UE radio capabilities verified flag to one when the first hash matches the second hash.

30. The core network node of claim 24, wherein the processor and the memory are further configured to:
access pre-stored UE radio capability information for the UE;
compute a third hash of the pre-stored UE radio capability information;
compare the first hash to the third hash; and
transmit the UE radio capability information request to the RAN node when the first hash does not match the third hash.
